(19) United States
(12) Patent Application Publication
(10) Pub. No.: US 2026/0016306 A1
(43) Pub. Date: Jan. 15, 2026

(54) CLOUD-BASED PACKAGE DELIVERY AND VEHICLE ENERGY CONSUMPTION BASED RIDER REMUNERATION

(71) Applicant: American Honda Motor Co., Inc., Torrance, CA (US)

(72) Inventors: JAMIE DAVIES, HUNTINGTON BEACH, CA (US); DEVON J FUJIOKA, LOS ANGELES, CA (US)

(21) Appl. No.: 18/767,141

(22) Filed: Jul. 9, 2024

(51) Int. Cl. G01C 21/34; G01C 21/36; G06Q 10/0835

(52) U.S. Cl. CPC G01C 21/3469; G01C 21/3691; G06Q 10/083; G06Q 10/08355

(57) ABSTRACT

A first electronic device and a method for cloud-based package delivery and vehicle energy consumption based rider remuneration are provided. The first electronic device comprises a circuitry. The circuitry receives first information indicative of first delivery request of first package from a source location to a target location. The circuitry selects one or more vehicles from a set of vehicles, based on vehicle information of each vehicle, and further based on a first package profile. The circuitry determines one or more delivery routes for the first delivery request, based on driver information and the first information. The circuitry transmits the one or more delivery routes to one or more second electronic devices. The circuitry receives energy consumption information for each vehicle, based on the one or more delivery routes. The circuitry determines remuneration information for the driver, based on the energy consumption information.

### BACKGROUND

In the recent years, package delivery services have become a cornerstone of commerce, facilitating the movement of goods across diverse geographies. The package delivery services may rely on a network of vehicles, often equipped with advanced technology such as dedicated processors or applications, to manage communication and navigation. For example, such processors or applications may gather data on vehicle location, speed, and fuel efficiency, which may then be processed to optimize delivery routes. However, existing systems may face challenges in route optimization, which may result in higher operational costs and environmental impact. Additionally, considerations such as driver well-being and incentive structures may not be fully integrated into current delivery models, potentially affecting driver performance and overall service effectiveness.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, a first electronic device is provided. The first electronic device may include a circuitry. The circuitry may receive first information indicative of a first delivery request of a first package from a source location to a target location. The first package may be associated with a first package profile. The circuitry may further select one or more vehicles from a set of vehicles, based on vehicle information associated with each vehicle of the set of vehicles, and further based on the first package profile. The circuitry may further determine one or more delivery routes associated with the first delivery request, based on driver information associated with a driver of each vehicle of the selected one or more vehicles, and the received first information. The circuitry may further transmit the determined one or more delivery routes to one or more second electronic devices associated with the selected one or more vehicles. The circuitry may further receive energy consumption information associated with each vehicle of the selected one or more vehicles, based on the transmitted one or more delivery routes. The circuitry may further determine remuneration information associated with the driver of each vehicle of the selected one or more vehicles, based on the received energy consumption information.

According to another embodiment of the disclosure, a first vehicle is provided. The first vehicle may include a telematics control unit (TCU). The TCU may transmit, to a first electronic device, driver information and vehicle information associated with the first vehicle. The TCU may further receive, from the first electronic device, the one or more delivery routes associated with the first delivery request of the first package from the source location to the target location. The first package is associated with the first package profile. The received one or more delivery routes are determined based on the driver information, and the first information indicative of the first delivery request. The first vehicle is selected from the set of vehicles, based on the vehicle information and the first package profile. The TCU may further determine the energy consumption information associated with the first vehicle, based on the received one or more delivery routes. The TCU may further receive the remuneration information associated with the driver of the first vehicle, based on the received energy consumption information.

According to another embodiment of the disclosure, a method in the first electronic device is provided. The method may include reception of the first information indicative of the first delivery request of the first package from the source location to the target location. The first package is associated with the first package profile. The method may further include selection of the one or more vehicles from the set of vehicles, based on the vehicle information associated with each vehicle of the set of vehicles, and further based on the first package profile. The method may further include determination of the one or more delivery routes associated with the first delivery request, based on the driver information associated with the driver of each vehicle of the selected one or more vehicles, and the received first information. The method may further include transmission of the determined one or more delivery routes to the one or more second electronic devices associated with the selected one or more vehicles. The method may further include reception of the energy consumption information associated with each vehicle of the selected one or more vehicles, based on the received energy consumption information.

### BRIEF DESCRIPTION OF THE DRAWINGS

FIG. 1 is a block diagram that illustrates an exemplary network environment for cloud-based package delivery and vehicle energy consumption based rider remuneration, in accordance with an embodiment of the disclosure.

FIG. 2 is a block diagram that illustrates an exemplary first electronic device of FIG. 1, in accordance with an embodiment of the disclosure.

FIG. 3 is a block diagram that illustrates an exemplary vehicle of FIG. 1, in accordance with an embodiment of the disclosure.

FIG. 4 is a diagram that illustrates an execution pipeline for cloud-based package delivery and vehicle energy consumption based rider remuneration, in accordance with an embodiment of the disclosure.

FIG. 5A is a block diagram that illustrates an exemplary scenario for cloud-based package delivery and vehicle energy consumption based rider remuneration, in accordance with one embodiment of the disclosure.

FIG. 5B is a block diagram that illustrates an exemplary scenario for cloud-based package delivery and vehicle energy consumption based rider remuneration, in accordance with another embodiment of the disclosure.

FIG. 6A is a block diagram that illustrates an exemplary scenario for cloud-based operation to facilitate package delivery and vehicle energy consumption based rider remuneration, in accordance with a first embodiment of the disclosure.

FIG. 6B is a block diagram that illustrates an exemplary scenario for cloud-based operation to facilitate package delivery and vehicle energy consumption based rider remuneration, in accordance with a second embodiment of the disclosure.

FIG. 6C is a block diagram that illustrates an exemplary scenario for cloud-based operation to facilitate package delivery and vehicle energy consumption based rider remuneration, in accordance with a third embodiment of the disclosure.

FIG. 7 is a flowchart that illustrates exemplary operations of a method for cloud-based package delivery and vehicle energy consumption based rider remuneration, in accordance with one embodiment of the disclosure.

FIG. 8 is a flowchart that illustrates exemplary operations of a method for cloud-based package delivery and vehicle energy consumption based rider remuneration, in accordance with another embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in a disclosed first electronic device and a method for cloud-based package delivery and vehicle energy consumption based rider remuneration. Exemplary aspects of the disclosure provide a first electronic device that may comprise a circuitry. The circuitry may be configured to receive first information indicative of a first delivery request of a first package from a source location to a target location. The first package may be associated with a first package profile. The circuitry may be further configured to select one or more vehicles from a set of vehicles, based on vehicle information associated with each vehicle of the set of vehicles, and further based on the first package profile. The circuitry may be further configured to determine one or more delivery routes associated with the first delivery request, based on driver information associated with a driver of each vehicle of the selected one or more vehicles, and the received first information. The circuitry may be further configured to transmit the determined one or more delivery routes to one or more second electronic devices associated with the selected one or more vehicles. The circuitry may be further configured to receive energy consumption information associated with each vehicle of the selected one or more vehicles, based on the transmitted one or more delivery routes. The circuitry may be further configured to determine remuneration information associated with the driver of each vehicle of the selected one or more vehicles, based on the received energy consumption information.

Traditional delivery models may often depend on a static fleet and fixed routes, which can lead to suboptimal fuel consumption, increased delivery times, and underutilization of resources. The present disclosure provides an electronic device and a cloud-based system designed to enhance the efficiency of package delivery services. The electronic device of the disclosure may employ a network of diverse vehicles, each equipped with a Telematics Control Unit (TCU) or a compatible phone application, to facilitate communication with a centralized cloud platform. The cloud platform may play a central role in dynamically routing vehicles to designated pick-up and delivery points, taking into account the specific characteristics of each package and the available vehicle information. In contrast to the traditional delivery models, the disclosed dynamic routing based on characteristics of each package and available vehicles may lead to fuel saving, reduced delivery time, and efficient utilization of the vehicles.

The disclosed electronic device may be equipped with circuitry that performs several functions to streamline the delivery process. The circuitry may receive information about a delivery request, including an origin and destination of a package, as well as details about the package itself. Based on the received information and profiles of available vehicles and drivers, the electronic device may select suitable vehicles and calculate efficient delivery routes. The delivery routes may then be communicated to the corresponding TCUs or electronic devices associated with the vehicles. The disclosed electronic device may also gather data on the energy consumed during delivery, which may be used to determine appropriate compensation for the drivers, thereby incentivizing efficient energy use and route adherence.

The disclosed electronic device may allow for real-time adjustments to delivery routes, ensuring that vehicles are used in the most efficient manner possible. By considering factors such as cargo size, vehicle availability, and fuel efficiency, the electronic device of the disclosure can reduce operational costs and environmental impact. Additionally, the provision of remuneration to drivers based on energy consumption of the vehicles of the respective drivers data may encourage the drivers to operate their vehicles more efficiently, which can lead to further cost savings and a reduction in carbon emissions. Overall, the disclosed electronic device may provide a substantial improvement over conventional delivery methods, offering a more adaptable, efficient, and environmentally friendly approach to package delivery.

Reference will now be made in detail to specific aspects or features, examples of which are illustrated in the accompanying drawings. Wherever possible, corresponding or similar reference numbers will be used throughout the drawings to refer to the same or corresponding parts.

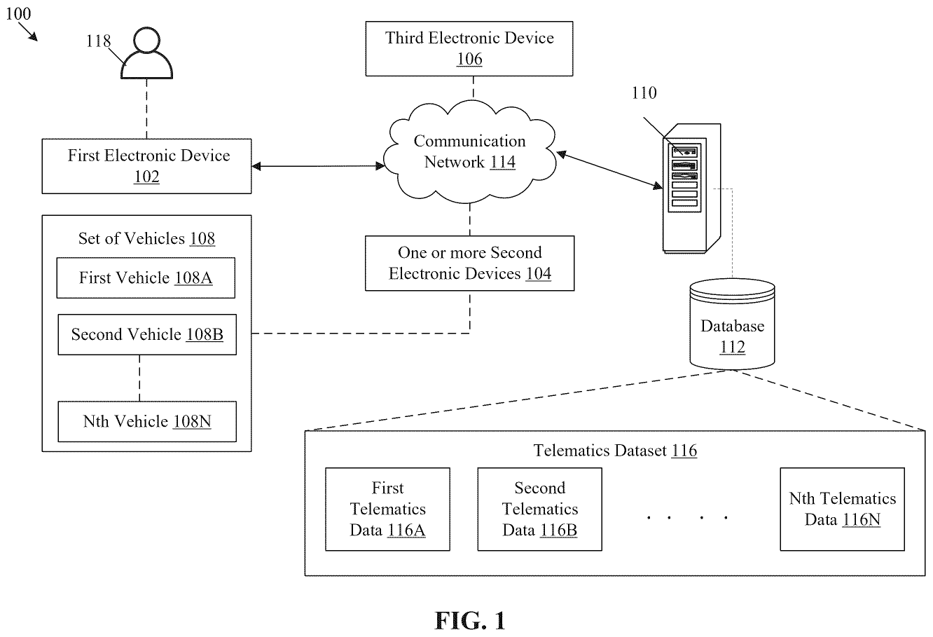

FIG. 1 is a block diagram that illustrates an exemplary network environment for cloud-based package delivery and vehicle energy consumption based rider remuneration, in accordance with an embodiment of the disclosure. With reference to FIG. 1, there is shown a network environment diagram 100. The network environment diagram 100 may include a first electronic device 102, one or more second electronic devices 104, a third electronic device 106, a set of vehicles 108, a server 110, and a database 112. The first electronic device 102, the one or more second electronic devices 104, the third electronic device 106, the set of vehicles 108, the server 110 and the database 112 may be communicatively coupled to each other via a communication network 114. For example, the set of vehicles 108 may include a first vehicle 108A, a second vehicle 108B, . . . and an Nth vehicle 108N. Further, the database 112 may include information such as, driver data, vehicle data, delivery request data, and delivery package data. In FIG. 1, there is further shown that the database 112 may include telematics dataset 116 associated with the set of vehicles 108. For example, the telematics dataset 116 may include first telematics data 116A associated with the first vehicle 108A, second telematics data 116B associated with the second vehicle 108B, . . . and Nth telematics data 116N associated with the Nth vehicle 108N. Further, there is shown a user 118 who may operate or be associated with the first electronic device 102.

Though the set of vehicles 108 and the telematics dataset 116 in FIG. 1 have been shown to include “N” vehicles and “N” data subsets, respectively, the scope of the disclosure may not be so limited. The set of vehicles 108 may include one vehicle or more than “N” vehicles and the telematics dataset 116 may include one data subset or more than “N” data subsets, without departing from the spirit of the disclosure.

The first electronic device 102 may include suitable logic, control circuitry, interfaces, and/or code that may be configured to receive first information indicative of a first delivery request of a first package from a source location to a target location. The first package may be associated with the first package profile. Further, the first electronic device 102 may select one or more vehicles from the set of vehicles 108, based on vehicle information associated with each vehicle of the set of vehicles 108, and further based on the first package profile. Further, the first electronic device 102 may determine one or more delivery routes associated with the first delivery request, based on driver information associated with a driver of each vehicle of the selected one or more vehicles, and the received first information. Further, the first electronic device 102 may transmit the determined one or more delivery routes to the one or more second electronic devices 104 associated with the selected one or more vehicles. Further, the first electronic device 102 may receive energy consumption information associated with each vehicle of the selected one or more vehicles, based on the transmitted one or more delivery routes. Further, the first electronic device 102 may determine remuneration information associated with the driver of each vehicle of the selected one or more vehicles, based on the received energy consumption information.

Examples of the first electronic device 102 may include, but are not limited to, a computing device, a smartphone, a cellular phone, a mobile phone, a computer work-station, a consumer electronic (CE) device, a vehicle remote controller device, a user wearable device, and/or any computing device that may be capable to remotely control the set of vehicles 108. In an embodiment, the first electronic device 102 may be associated with at least one of a vehicle manufacturer, a vehicle dealer, a vehicle vendor, a service provider, an infrastructure provider, or the driver associated with the vehicle.

The one or more second electronic devices 104 may include suitable logic, control circuitry, interfaces, and/or code that may be configured to transmit, to the first electronic device 102, the driver information and the vehicle information associated with a first vehicle 108A of the set of vehicles 108. The first vehicle 108A may be selected from the set of vehicles 108, based on the vehicle information and the first package profile. The one or more second electronic devices 104 may be further configured to receive from the first electronic device 102, the one or more delivery routes associated with the first delivery request of the first package from the source location to the target location. The first package may be associated with the first package profile. The received one or more delivery routes may be determined based on the driver information and the first information indicative of the first delivery request. In some embodiments, each of the one or more second electronic devices 104 may be configured to determine the one or more delivery routes associated with the first delivery request, based on the driver information associated with the driver of each vehicle of the selected one or more vehicles, and the received first information. The one or more second electronic devices 104 may be further configured to determine the energy consumption information associated with the first vehicle 108A, based on the received one or more delivery routes. The one or more second electronic devices 104 may be further configured to receive the remuneration information associated with the driver of the first vehicle 108A, based on the received energy consumption information.

Examples of the one or more second electronic devices 104 may include, but are not limited to, a computing device, a smartphone, a cellular phone, a mobile phone, a mainframe machine, a server, a computer work-station, a consumer electronic (CE) device, a vehicle remote controller device, a user wearable device, and/or any computing device that may be associated with the selected one or more vehicles.

The third electronic device 106 may be an electronic device used by one or more retailers. The third electronic device 106 may be configured to receive the first information indicative of the first delivery request of the first package from the source location to the target location. The first package profile may be associated with the first package profile. The third electronic device 106 may receive a user input associated with information related about the first package profile from the one or more retailers. Examples of the third electronic devices 106 may include, but are not limited to, a computing device, a smartphone, a cellular phone, a mobile phone, a mainframe machine, a server, a computer work-station, a consumer electronic (CE) device, a vehicle remote controller device, a user wearable device, and/or any computing device that may be associated with a retailer of a vehicle of the set of vehicles 108.

Each vehicle of the set of vehicles 108 may include suitable logic, control circuitry, interfaces, and/or code that may be configured to receive the first information indicative of the first delivery request of the first package from the source location to the target location. The first package may be associated with the first package profile. Further, each vehicle of the set of vehicles 108 may transmit to the first electronic device 102, the driver information and the vehicle information associated with the first vehicle 108A. Further, each vehicle of the set of vehicles 108 may receive, from the first electronic device 102, the one or more delivery routes associated with the first delivery request of the first package from the source location to the target location. The received one or more delivery routes may be determined based on the driver information, and the first information indicative of the first delivery request. The first vehicle 108A may selected from the set of vehicles 108, based on the vehicle information and the first package profile. The received one or more delivery routes may correspond to route recommendations for the first vehicle 108A to fulfill the first delivery request. Further, each vehicle of the set of vehicles 108 may determine the energy consumption information associated with the first vehicle 108A, based on the received one or more delivery routes. Further, each vehicle of the set of vehicles 108 may receive the remuneration information associated with the driver of the first vehicle 108A, based on the received energy consumption information.

Each vehicle of the set of vehicles 108 may be a non-autonomous vehicle, a semi-autonomous vehicle, or a fully autonomous vehicle. Examples of the set of vehicles 108 may include, but are not limited to, a two-wheeler vehicle, a three-wheeler vehicle, a four-wheeler vehicle, a hybrid vehicle, or a vehicle with autonomous drive capability that uses one or more distinct renewable or non-renewable power sources. A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. Each vehicle of the set of vehicles 108 may be a system through which the driver may travel from the source location to the target location. Examples of the two-wheeler vehicle may include, but are not limited to, an electric two-wheeler, an internal combustion engine (ICE)-based two-wheeler, or a hybrid two-wheeler. Similarly, examples of the four-wheeler vehicle may include, but are not limited to, an electric car, an internal combustion engine (ICE)-based car, a fuel-cell based car, a solar powered-car, or a hybrid car. The present disclosure may be also applicable to other types of two-wheelers (e.g., a scooter) or four-wheelers. The description of other types of each of the set of vehicles 108 has been omitted from the disclosure for the sake of brevity. Each vehicle of the set of vehicles 108 may be registered to a corresponding owner based on vehicle identification information associated with the corresponding vehicle.

The server 110 may include suitable logic, control circuitry, and interfaces, and/or code that may be configured to receive the first information indicative of the first delivery request of the first package from the source location to the target location. The first package may be associated with the first package profile. The server 110 may select the one or more vehicles from the set of vehicles 108, based on the vehicle information associated with each vehicle of the set of vehicles 108, and further based on the first package profile. The server 110 may determine the one or more delivery routes associated with the first delivery request, based on the driver information associated with the driver of each vehicle of the selected one or more vehicles, and the received first information. The server 110 may transmit the determined one or more delivery routes to the one or more second electronic devices 104 associated with the selected one or more vehicles. The server 110 may receive the energy consumption information associated with each vehicle of the selected one or more vehicles, based on the transmitted one or more delivery routes. The server 110 may determine the remuneration information associated with the driver of each vehicle of the selected one or more vehicles, based on the received energy consumption information.

The server 110 may be implemented as a cloud server and may execute operations through web applications, cloud applications, HTTP requests, repository operations, file transfer, and the like. Other example implementations of the server 110 may include, but are not limited to, a database server, a file server, a web server, a media server, an application server, a mainframe server, or a cloud computing server.

In at least one embodiment, the server 110 may be implemented as a plurality of distributed cloud-based resources by use of several technologies that are well known to those ordinarily skilled in the art. A person with ordinary skill in the art will understand that the scope of the disclosure may not be limited to the implementation of the server 110 and third electronic device 106 as two separate entities. In certain embodiments, the functionalities of the server 110 can be incorporated in its entirety or at least partially in the third electronic device 106, without a departure from the scope of the disclosure.

The database 112 may include suitable logic, interfaces, and/or code that may be configured to store information related to the vehicle data, the driver data, the delivery request data, and the delivery package data. In an example, the database 112 may store the telematics dataset 116. The database 112 may be derived from data off a relational or non-relational database, or a set of comma-separated values (csv) files in conventional or big-data storage. The database 112 may be stored or cached on a device, such as a server (e.g., the server 110) or the first electronic device 102. The device storing the database 112 may be configured to receive a query for the first information indicative of the first delivery request of the first package from the source location to the target location from the server 110 and/or the first electronic device 102. In response, the device of the database 112 may be configured to retrieve and provide the queried first information indicative of the first delivery request of the first package associated with the third electronic device 106 to the server 110 and/or the first electronic device 102 based on the received query. In some embodiments, the device storing the database 112 may receive a query for the telematics dataset 116 (or a part thereof). In response to such a request, the device of the database 112 may retrieve and provide the queried telematics dataset 116 (or the part thereof) to the server 110 and/or the first electronic device 102.

In some embodiments, the database 112 may be hosted on a plurality of servers stored at same or different locations. The operations of the database 112 may be executed using hardware including a processor, a microprocessor (e.g., to perform or control performance of one or more operations), a field-programmable gate array (FPGA), or an application-specific integrated circuit (ASIC). In some other instances, the database 112 may be implemented using software.

The communication network 114 may include a communication medium through which the first electronic device 102, the one or more second electronic devices 104, the third electronic device 106, the set of vehicles 108, the server 110 and the database 112 may communicate with each other. The communication network 114 may be one of a wired connection or a wireless connection. Examples of the communication network 114 may include, but are not limited to, the Internet, a cloud network, Cellular or Wireless Mobile Network (such as Long-Term Evolution and 5G New Radio), satellite network (e.g., a network of a set of low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 114 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

In an embodiment, each data subset of the telematics dataset 116 may be associated with a corresponding vehicle of the set of vehicles 108. Telematics data (e.g., the first telematics data 116A) may correspond to at least one of on-board diagnostic data (OBD) parameters of a vehicle (e.g., the first vehicle 108A), speed information of the vehicle, acceleration and deacceleration information of the vehicle, a health status of the vehicle, road conditions related to a route of the vehicle, weather conditions related to the route of the vehicle, location information of the route of the vehicle, tachometer information of the vehicle, over-speeding information of the vehicle, lane-changing information of the vehicle, driving behavior of a driver of the vehicle, vehicle occupancy information of the vehicle, fuel efficiency information of the vehicle, engine tuning information of the vehicle, battery charging information of the vehicle, batter health information of the vehicle, tire pressure information of the vehicle, or maintenance/service information of the vehicle.

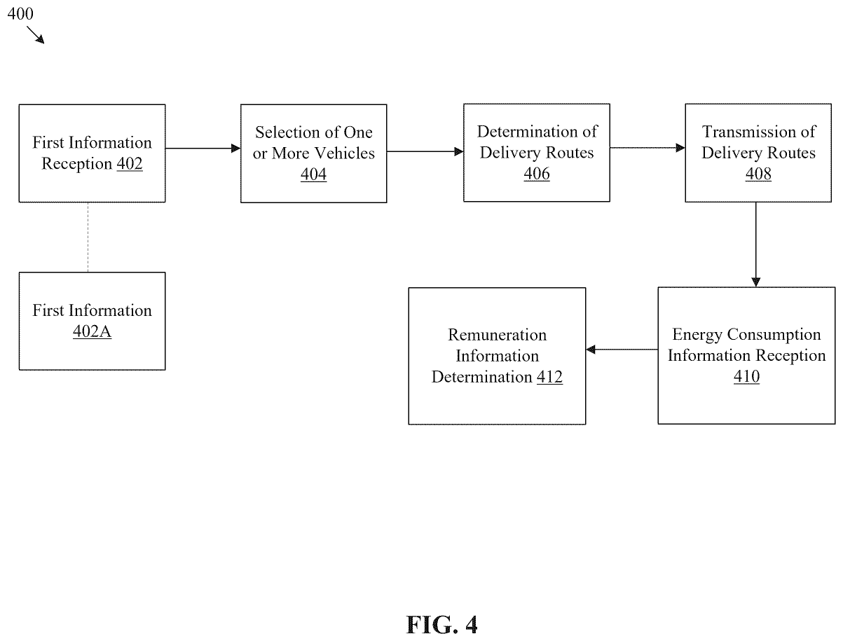

In operation, the first electronic device 102 may receive the first information indicative of the first delivery request of the first package from the source location to the target location. In an embodiment, the first package may be associated with the first package profile. Details related to the reception of the first information are further provided, for example, in FIG. 4 (at 402).

The first electronic device 102 may select the one or more vehicles from the set of vehicles 108, based on the vehicle information associated with each vehicle of the set of vehicles 108, and further based on the first package profile. The vehicle information may include at least one of a vehicle model, a vehicle type, a fuel efficiency, a carbon footprint, a cost of operation, a vehicle age, a vehicle mileage, or a cargo size associated with each vehicle of the selected one or more vehicles. The first package profile may include at least one of a size of the first package, dimensions of the first package, quantity of items in the first package, weight of the first package, or transportation requirements associated with the first package. Details related to the selection of the one or more vehicles from the set of vehicles are further provided, for example, in FIG. 4 (at 404).

The first electronic device 102 may determine the one or more delivery routes associated with the first delivery request, based on the driver information associated with the driver of each vehicle of the selected one or more vehicles, and the received first information. Details related to the determination of the one or more delivery routes associated with the first delivery request are further provided, for example, in FIG. 4 (at 406).

The first electronic device 102 may transmit the determined one or more delivery routes to the one or more second electronic devices 104 associated with the selected one or more vehicles. Each of the one or more second electronic devices 104 may receive the transmitted one or more delivery routes. The selected one or more vehicles may be navigated based on the one or more delivery routes received at the one or more second electronic devices 104. Details related to the transmission of the determined one or more delivery routes are further provided, for example, in FIG. 4 (at 408).

The first electronic device 102 may receive the energy consumption information associated with each vehicle of the selected one or more vehicles, based on the transmitted one or more delivery routes. Each vehicle of the selected one or more vehicles may monitor telematics data related to the corresponding vehicle, based on the operation of the vehicle to fulfill the first delivery request. The energy consumption information associated with each vehicle of the selected one or more vehicles may be determined based on the monitored telematics data related to the corresponding vehicle. Details related to the reception of the energy consumption information associated with each of the selected one or more vehicles are further provided, for example, in FIG. 4 (at 410).

The first electronic device 102 may determine the remuneration information associated with the driver of each vehicle of the selected one or more vehicles, based on the received energy consumption information. For example, a remuneration of a driver may be determined based on, for example, an adherence to the transmitted one or more delivery routes, carbon emissions, fuel efficiency, and the like. Details related to the determination of the remuneration information associated with the driver of each of the selected one or more vehicles are further provided, for example, in FIG. 4 (at 412).

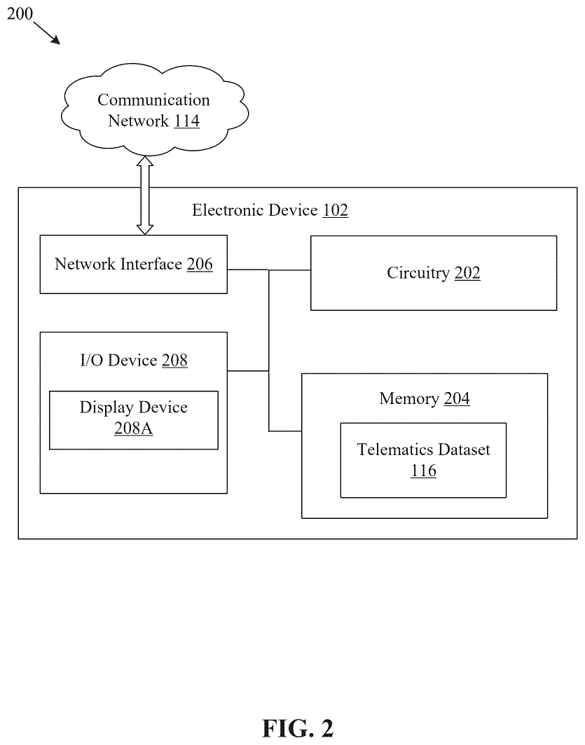

FIG. 2 is a block diagram that illustrates an exemplary first electronic device of FIG. 1, in accordance with an embodiment of the disclosure. FIG. 2 is explained in conjunction with elements from FIG. 1. With reference to FIG. 2, there is shown a block diagram 200 of the first electronic device 102. The first electronic device 102 may include a circuitry 202, a memory 204, a network interface 206, and an input/output (I/O) device 208. The input/output device 208 may include a display device 208A. Although in FIG. 2, it is shown that the first electronic device 102 includes the circuitry 202, the memory 204, the network interface 206, and the input/output (I/O) device 208; however, the disclosure may not be so limiting, and the first electronic device 102 may include less or more components to perform the same or other functions of the first electronic device 102. Details of the other functions or components have been omitted from the disclosure for the sake of brevity.

The circuitry 202 may include suitable logic, control circuitry, and interfaces that may be configured to execute program instructions associated with different operations to be executed by the first electronic device 102. For example, some of the operations may include, first information reception, one or more vehicles selection, delivery routes determination, delivery routes transmission, energy consumption information reception, and remuneration information determination. The circuitry 202 may include one or more specialized processing units, which may be implemented as a separate processor. In an embodiment, the one or more specialized processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, control circuitry, and interfaces that may be configured to store the one or more instructions to be executed by the circuitry 202. The memory 204 may be configured to store the vehicle data, the driver data, the delivery request data, and the delivery package data. In an example, the memory 204 may store the telematics dataset 116. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 206 may include suitable logic, control circuitry, and interfaces that may be configured to facilitate communication between the first electronic device 102, the one or more second electronic devices 104, the third electronic device 106, the set of vehicles 108, the server 110 and the database 112, via the communication network 114. The network interface 206 may be implemented by use of various known technologies to support wired or wireless communication of the first electronic device 102 with the communication network 114. The network interface 206 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer control circuitry. The network interface 206 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation New Radio (5G NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging, and a Short Message Service (SMS).

The I/O device 208 may include suitable logic, control circuitry, and interfaces that may be configured to receive an input from the user and provide an output based on the received input. For example, the first information may be received as a user input, via the I/O device 208. Further, details related to the first information, the selected one or more vehicles, the determined one or more delivery routes, the received energy consumption information, and the determined remuneration information may be output, via the I/O device 208. The I/O device 208 which may include various input and output devices, may be configured to communicate with the first electronic device 102 or the server 110. Examples of the I/O device 208 may include, but are not limited to, a touch screen, a keyboard, a mouse, a joystick, a microphone, a display device (e.g., the display device 208A), a haptic device, and a speaker.

The display device 208A may include suitable logic, control circuitry, and interfaces that may be configured to display the received first information, the selected one or more vehicles, the determined one or more delivery routes, the received energy consumption information, and the determined remuneration information. The display device 208A may be a touch screen which may enable the driver to provide a driver-input, via the display device 208A. The display device 208A may be a touch screen which may display the first information, the determined one or more delivery routes, the energy consumption information, and the remuneration information to the driver. The touch screen may be at least one of a resistive touch screen, a capacitive touch screen, or a thermal touch screen. The display device 208A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 208A may refer to a display screen of a head mounted device (HMD), a smart-glass device, a see-through display, a projection-based display, an electro-chromic display, or a transparent display.

The functions or operations executed by the first electronic device 102, as described in FIG. 1, may be performed by the circuitry 202. Operations executed by the circuitry 202 are described in detail, for example, in FIG. 4.

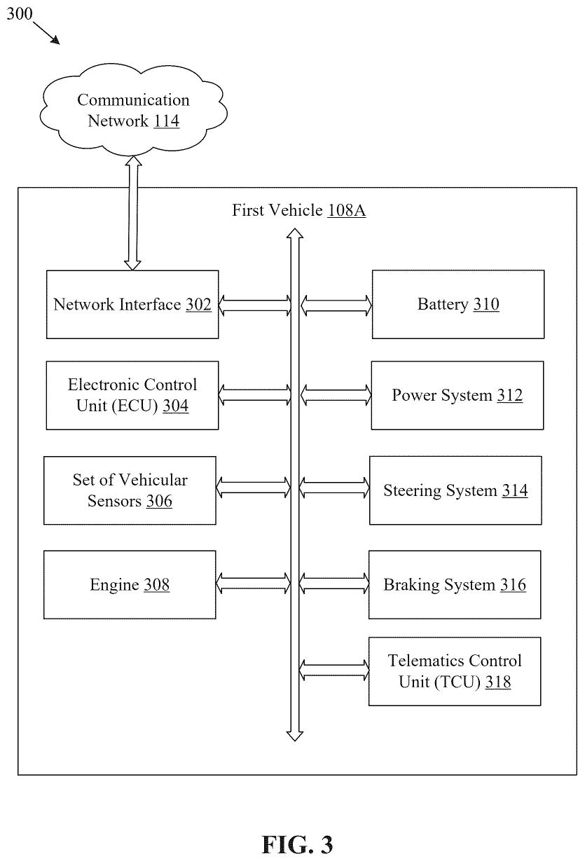

FIG. 3 is a block diagram that illustrates an exemplary vehicle of FIG. 1, in accordance with an embodiment of the disclosure. FIG. 3 is explained in conjunction with elements from FIG. 1 and FIG. 2. With reference to FIG. 3, there is shown a block diagram 300 of the first vehicle 108A. The first vehicle 108A may include a network interface 302, an electronic control unit (ECU) 304, a set of vehicular sensors 306, an engine 308, a battery 310, a power system 312, a steering system 314, a braking system 316, and a telematics control unit (TCU) 318. Although in FIG. 3, it is shown that the first vehicle 108A includes the network interface 302, the electronic control unit 304, the set of vehicular sensors 306, the engine 308, the battery 310, the power system 312, the steering system 314, the braking system 316, and the TCU 318; however, the disclosure may not be so limiting, and the first vehicle 108A may include less or more components to perform the same or other functions of the first vehicle 108A. Details of the other functions or components have been omitted from the disclosure for the sake of brevity.

The network interface 302 may include suitable logic, control circuitry, and interfaces that may be configured to facilitate communication between the first vehicle 108A, the first electronic device 102, the one or more second electronic devices 104, the third electronic device 106, and the server 110, via the communication network 114. The network interface 302 may be implemented by use of various known technologies to support wired or wireless communication of the first vehicle 108A with the communication network 114. The network interface 302 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer control circuitry. The network interface 302 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation New Radio (5G NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The electronic control unit (ECU) 304 may include suitable logic, control circuitry, interfaces, and/or code that may be configured to activate or deactivate the set of vehicular sensors 306 and the TCU 318. The electronic control unit 304 may be a specialized electronic control circuitry that may include an ECU processor to control different functions, such as, but not limited to, engine operations, communication operations, and data acquisition of the first vehicle 108A. In an embodiment, the electronic control unit 304 may be a microprocessor. Other examples of the electronic control unit 304 may include, but are not limited to, a vehicle control system, an in-vehicle infotainment (IVI) system, an in-car entertainment (ICE) system, an automotive Head-up Display (HUD), an automotive dashboard, an embedded device, a smartphone, a human-machine interface (HMI), a computer workstation, a handheld computer, a cellular/mobile phone, a portable consumer electronic (CE) device, a server, and other computing devices. The electronic control unit 304 may be included or integrated in the first vehicle 108A.

In an embodiment, the electronic control unit 304 may be a control circuitry that may be configured to receive the first information indicative of the first delivery request of the first package from the source location to the target location. The first package may be associated with the first package profile. The control circuitry may select the one or more vehicles from the set of vehicles 108, based on the vehicle information associated with each vehicle of the set of vehicles 108, and further based on the first package profile. The control circuitry may determine the one or more delivery routes associated with the first delivery request, based on the driver information associated with the driver of each vehicle of the selected one or more vehicles and the received first information. The control circuitry may transmit the determined one or more delivery routes to the one or more second electronic devices 104 associated with the selected one or more vehicles. The control circuitry may receive the energy consumption information associated with each vehicle of the selected one or more vehicles, based on the transmitted one or more delivery routes. The control circuitry may determine the remuneration information associated with the driver of each vehicle of the selected one or more vehicles, based on the received energy consumption information.

The set of vehicular sensors 306 may include a speedometer, an accelerometer, a location sensor, a tachometer, a weather sensor, an imaging sensor, a pressure sensor, a temperature sensor, a level sensor, a shock absorber, and the like. The speedometer may measure an instantaneous or an average speed of the first vehicle 108A. The accelerometer may measure an instantaneous or an average acceleration of the first vehicle 108A. The location sensor may determine a location of the first vehicle 108A. The tachometer may determine a speed in rotations per minute of the engine 308 of the first vehicle 108A. The weather sensor may determine a weather of the location of the first vehicle 108A. The imaging sensor may capture images of a region around the first vehicle 108A. The pressure sensor may determine a pressure of fluids (for example, engine oil, transmission oil, and hydraulic oil) of the first vehicle 108A. The level sensor may determine a level of fluids of the first vehicle 108A. The temperature sensor may determine a temperature of a region around the first vehicle 108A.

The engine 308 may be configured to provide power to the first vehicle 108A. The engine 308 may be an internal combustion engine with may include operations, for example, fuel injection, compression, ignition, or emission to power and drive the first vehicle 108A. The engine 308 may include various parts, for example, but are not limited to, a crankshaft, a cylinder, a spark plug, a piston, camshaft, a valve, combustion chamber, etc. In some embodiments, the engine 308 may include a motor in case of an electric motorcycle. The engine 308 may be two-stroke or four-stroke internal combustion engines. The engine 308 may include either one, two, three, four, or six cylinders. Examples of the engine 308 may include, but are not limited to, an inline engine (i.e. single cylinder, parallel twin, inline-triple, inline-four, inline-six), a V layout engine (i.e. V-twin engine, a V4 engine, a V8 engine), a flat (boxer) engine (i.e. flat-two, flat-four, flat-six), a lawn mower engine, a snow blower engine, or other motorcycle engines known in the art. A description of various parts of the engine 308 has been omitted from the disclosure for the sake of brevity.

The battery 310 may be a source of electric power for one or more electric circuits or loads (not shown). For example, the battery 310 may be a source of electrical power to a control circuitry (not shown) of the first vehicle 108A, network interface 302, the electronic control unit 304, the engine 308, the power system 312, the steering system 314, and the braking system 316. The battery 310 may be a rechargeable battery. The battery 310 may be the source of electrical power to start the engine 308 of the first vehicle 108A. In some embodiments, the battery 310 may correspond to a battery pack, which may have a plurality of clusters of batteries, which may be surrounded by a suitable coolant and a charge controller (not shown in FIG. 3). Examples of the battery 310 may include, but are not limited to, a lead acid battery, a nickel cadmium battery, a nickel-metal hydride battery, a lithium-ion battery, and other rechargeable batteries.

The power system 312 may include suitable logic, control circuitry, interfaces, and/or code that may be configured to control electric power which may be output to various electric circuits and loads of the first vehicle 108A. The power system 312 may include a battery (not shown) to provide the electric power to perform various electrical operations of the first vehicle 108A. The power system 312 may provide the electric power for functioning of different components (such as, the electronic control unit 304, a communication system, the steering system 314, and the set of vehicular sensors 306) of the first vehicle 108A. The power system 312 may be configured to receive control signals from the processor to control the electronic control unit 304, the communication system, the steering system 314, and the set of vehicular sensors 306 of the first vehicle 108A. The power system 312 may be configured to control the charging and the discharging of the battery 310 and an auxiliary battery based on the received control signals. The power system 312 may be configured to control the transfer of the electric energy between the power system 312 and the communication system, the set of vehicular sensors 306, the steering system 314, and the set of vehicular sensors 306 of the first vehicle 108A. Examples of the power system 312 may include, but are not limited to, an electric charge/discharge controller, a charge regulator, a battery regulator, a battery management system, an electric circuit breaker, a power electronic drive control system, an Application-Specific Integrated Circuit (ASIC) processor, and/or other energy-control hardware processors.

The steering system 314 may receive one or more control commands from the user. The steering system 314 may include a steering wheel/handlebar and/or an electric motor (provided for a power-assisted steering) that may be used by a driver to control movement of the first vehicle 108A in manual mode or a semi-autonomous mode. In accordance with an embodiment, the movement or steering of the first vehicle 108A may be automatically controlled when the first vehicle 108A is in autonomous mode. Examples of the steering system 314 may include, but are not limited to, an autonomous steering control, a power-assisted steering system, a vacuum/hydraulic-based steering system, an electro-hydraulic power-assisted system (EHPAS), or a “steer-by-wire” system, or an autonomous steering system, known in the art.

The braking system 316 may be used to stop or slow down the first vehicle 108A by application of resistive forces, such as electromagnetic and/or frictional forces. The braking system 316 may receive a command from a powertrain control system under the control of a control circuitry when the first vehicle 108A is in an autonomous mode or a semi-autonomous mode. In accordance with an embodiment, the braking system 316 may receive a command from the control circuitry when the control circuitry preemptively detects intent of the driver to perform a specific task which requires the driver to apply brakes.

The TCU 318 may include suitable logic, control circuitry, and interfaces that may be configured to activate or deactivate each vehicular sensor of the set of vehicular sensors 306 of the first vehicle 108A based on certain conditions. Further, the TCU 318 may receive outputs of each vehicular sensor of the set of vehicular sensors 306 to determine the first telematics data 116A associated with the first vehicle 108A. In an embodiment, the TCU 318 associated with the first vehicle 108A may be deactivated when the first vehicle 108A is switched off (or not charging, in case the first vehicle 108A is an electric vehicle). In an embodiment, the control circuitry of the ECU 304 may be further configured to activate the TCU 318 associated with the first vehicle 108A, based on the determination that the driver information and the vehicle information associated with first vehicle 108A is transmitted to the first electronic device 102.

FIG. 4 is a diagram that illustrates an execution pipeline for cloud-based package delivery and vehicle energy consumption based rider remuneration, in accordance with an embodiment of the disclosure. FIG. 4 is explained in conjunction with elements from FIG. 1, FIG. 2, and FIG. 3. With reference to FIG. 4, there is shown an execution pipeline 400 of exemplary operations from 402 to 412 that may be executed by the circuitry 202 of the first electronic device 102.

At 402, an operation of first information reception may be executed. In an embodiment, the circuitry 202 may be configured to receive first information 402A that may be indicative of the first delivery request of the first package from the source location to the target location. The first package may be associated with the first package profile. It may be appreciated that the data related with the first delivery request may be stored in the database 112. In an example, the first information 402A may be received from the third electronic device 106, the server 110, and/or the database 112. The first information 402A may include a request for delivery of the first package including one or more items (e.g., consumer electronic products) from the source location (e.g., a warehouse of the retailer) to the target location (e.g., a customer's premises). The first package profile of the first package may include, but is not limited to, a size of the first package, dimensions of the first package, quantity of items in the first package, weight of the first package, or transportation requirements associated with the first package. For example, the first package may be a cube of a size of 3 inches by 3 inches by 3 inches, the first package may include 3 items, the weight of the first package may be 300 grams, and the first package may need to be refrigerated during transportation and storage.

At 404, an operation of selection of one or more vehicles may be executed. In an embodiment, the circuitry 202 may be configured to select the one or more vehicles from the set of vehicles 108, based on the vehicle information associated with each vehicle of the set of vehicles 108 and further based on the first package profile. In an embodiment, the vehicle information may include at least one of a vehicle model, a vehicle type, a fuel efficiency, a carbon footprint, a cost of operation, a vehicle age, a vehicle mileage, or a cargo size associated with each vehicle of the selected one or more vehicles.

For instance, a retailer may request the delivery of a small parcel including electronics, which due to its compact size and fragility, could be ideally suited for delivery by a motorcycle courier who can navigate traffic more efficiently and ensure the package is handled delicately. Conversely, a large box containing home appliances may require the use of a cargo van to accommodate its bulk and weight, ensuring safe and secure transport. The source location for the deliveries could vary; the small parcel may be picked up from a high-street electronics store, while the large box may be dispatched from a warehouse located on the outskirts of the city. The target locations could be equally diverse, with the small parcel being delivered to a residential apartment in a busy downtown area, necessitating a delivery route that avoids traffic hotspots, and the large box being delivered to a suburban home, where the route may be optimized for distance travelled. In each case, the specific characteristics of the package and the start and end points of the delivery journey may play a central role in the determination of an appropriate vehicle and the delivery route to be taken, with the aim of ensuring timely, efficient, and safe delivery.

In another example, a delivery request for a set of fragile glassware may necessitate a vehicle with a smooth suspension system to minimize the risk of breakage during transit. In such a case, a sedan with a reputation for a comfortable ride may be selected over a stiffer-riding sports car. Alternatively, a delivery request for refrigerated goods may require a vehicle equipped with a refrigeration unit, leading to the selection of a specialized refrigerated truck.

The selection of the one or more vehicles may also be based on the driver information including preferences and capabilities of the drivers. For example, if a driver is known to be experienced with and prefers driving larger vehicles, a van or truck may be selected over a smaller car, even if the package size does not strictly require it. Conversely, if a driver prefers eco-friendly vehicles, an electric or hybrid vehicle may be chosen, aligning with the driver's values, and potentially reducing the carbon footprint of the delivery.

In another example, the vehicle information such as, a size of a vehicle may be relevant for navigating through narrow streets or fitting into tight parking spaces. Cargo capacity may be factored in to ensure that the vehicle can accommodate the volume of the first package or multiple such packages to be delivered. Fuel efficiency may be a factor, particularly for longer delivery routes or when optimizing for cost and environmental impact. Availability of the vehicles may also be important, as readily accessible vehicles that can be dispatched without delay may be prioritized over other vehicles.

In another example, the first package profile may indicate that the first package may be time-sensitive, prompting a selection of a vehicle that can ensure the fastest possible delivery. In such a case, the circuitry 202 may select a motorcycle that can navigate through traffic more effectively than a car, or select an electric bicycle for urban deliveries where parking and traffic congestion may be major concerns.

At 406, an operation of delivery routes determination may be executed. In an embodiment, the circuitry 202 may be configured to determine the one or more delivery routes associated with the first delivery request, based on the driver information associated with the driver of each vehicle of the selected one or more vehicles, and the received first information. It may be appreciated that the first information 402A may be received from the third electronic device 106 of the one or more retailers. In an embodiment, the driver information may include at least one of a lifestyle information, a habit information, a delivery servicing preference, a living location, a fitness information, days and times of travel, or commuting patterns associated with the driver.

For example, each delivery route may be determined based on the lifestyle information (such as, the driver's preferred working hours or days), habit information (such as, the driver's preferred routes or driving habits), a delivering servicing preference (such as, the driver's preference for delivering small packages or large packages). Further, each delivery route may be determined based on, a living location of the driver (which may influence the selection of pick-up and delivery locations), fitness information (which may be relevant if the vehicle is a bicycle or an electric bike), and days and time of travel (which may influence the determination of the delivery route. The delivery routes may be optimized to minimize travel time, energy consumption, and traffic congestion.

In an embodiment, the circuitry 202 may receive the vehicle information associated with each vehicle of the selected one or more vehicles. The determination of the one or more delivery routes may be further based on the vehicle information. In some cases, the vehicle information may play a crucial role in determination of optimal delivery routes. For instance, the delivery route may be determined based on specific characteristics of the vehicle, potentially leading to more efficient, cost-effective, and environmentally friendly deliveries.

For example, a delivery route for an electric vehicle may be designed to include charging stations along the way, ensuring the vehicle has sufficient charge to complete the delivery. The circuitry 202 may determine (or receive) the energy consumption information of the electric vehicle based on the vehicle's efficiency and the route's terrain, scheduling stops at charging points as needed. In another example, for a large truck that delivers multiple packages, the delivery route may be optimized to accommodate the vehicle's turning radius and height restrictions. The delivery route may be determined such that the determined delivery route may avoid narrow streets or low bridges that could pose challenges for the truck's size and weight.

In another example, in case of a motorcycle courier, the delivery route may be designed to take advantage of the vehicle's agility in urban environments. The delivery routes that allow lane splitting or use of dedicated bike lanes may be prioritized, potentially reducing delivery time in congested areas. In an example, in case of a refrigerated truck delivering perishable goods, the delivery route may be optimized to minimize the time the cargo (including the first package) may have to spend in transit. The vehicle's refrigeration capacity and energy consumption may be monitored to ensure the goods remain at the required temperature throughout the journey.

In an example, in case of a hybrid vehicle, the delivery route may be planned to maximize the use of electric power in urban areas with lower speed limits, switching to gasoline power for highway portions of the journey. Such an approach may optimize fuel efficiency and reduce emissions in densely populated areas. In another example, for a delivery van with a particular suspension system, the delivery route may be adjusted to avoid roads with poor conditions that could potentially damage the vehicle or its cargo. Thus, delivery routes including well-maintained roads that are suitable for the vehicle's specifications may be prioritized over other delivery routes.

In an embodiment, the circuitry 202 may be configured to determine, for each vehicle of the selected one or more vehicles, a recommended delivery route from the one or more delivery routes. The determination of the recommended delivery routes may be based on a current location of the driver and the energy consumption information associated with each vehicle of the selected one or more vehicles. Such an approach may help optimize delivery efficiency, reduce operational costs, and minimize environmental impact.

For example, in case of an urban delivery scenario, a delivery driver in a densely populated city may have multiple packages to deliver. Based on the delivery driver's current location, for example, in a downtown area, the circuitry 202 may recommend a route that efficiently covers all delivery points while minimizing energy consumption. For instance, if the driver is operating an electric vehicle, the recommended route may prioritize roads with less stop-and-go traffic to conserve battery power.

In another example, in case of a long-distance delivery, for a long-haul truck driver, the circuitry 202 may recommend a route that balances the shortest distance with the most fuel-efficient path. If the truck driver is currently at a rest stop, the recommended route may include strategic refueling points based on the truck's fuel consumption rate and tank capacity.

In another example, in case of a multi-modal delivery, where the first package may be required to be transferred between different modes of transport, the circuitry 202 may recommend routes that optimize the handover points. For instance, if the first package is to be transferred from a cargo bike to a van, the recommended route for the bike may prioritize reaching the handover point quickly, while the van's route may be optimized for fuel efficiency over the longer distance.

In an example of a weather-adaptive routing, the circuitry 202 may adjust the determined one or more recommendations based on current weather conditions and their impact on energy consumption. For instance, during a heatwave, the recommended route for a refrigerated truck may prioritize highways over surface streets to maintain a consistent speed and reduce the energy needed for cooling.

In an example of time-critical deliveries, the circuitry 202 may recommend a route that balances speed with energy efficiency. If a driver is currently in a low-traffic area but needs to make a delivery in a congested part of town, the recommended route may suggest using high-occupancy vehicle (HOV) lanes or toll roads if the time saved justifies the potential increase in energy consumption.

In an embodiment, the circuitry 202 may receive traffic information associated with the selected one or more vehicles. The determination of the one or more delivery routes may be further based on the traffic information. The received traffic information may include, but is not limited to, a network of available vehicles of the selected one or more vehicles, a current location of the available vehicles, or traffic patterns. For example, the determination of delivery routes may take into account real-time traffic data, which may be obtained from various sources such as traffic cameras, GPS tracking, and user-reported conditions. The real-time traffic data may be analyzed to identify areas of congestion, road closures, or other delays, allowing the system to reroute vehicles proactively to avoid such impediments. Additionally, weather conditions may be considered, as adverse weather can affect travel times and vehicle performance. For instance, routes may be adjusted to avoid areas prone to flooding during heavy rains or to select roads that are less likely to be impacted by snow and ice during winter conditions.

Furthermore, historical traffic patterns may be utilized to predict traffic conditions at different times of the day or on different days of the week. For example, if a particular route is known to experience heavy traffic during rush hour, the deliveries for that route may be scheduled during off-peak hours. Similarly, if a driver has a history of taking breaks at specific times, the system may schedule deliveries in a manner that aligns with the driver's natural break times, thereby minimizing disruptions and optimizing the delivery process. The driver's personal preferences, such as, a preference for scenic routes over highways, may also be used to determine the delivery routes to enhance driver satisfaction and retention.

At 408, an operation of delivery routes transmission may be executed. In an embodiment, the circuitry 202 may be configured to transmit the determined one or more delivery routes to the one or more second electronic devices 104 associated with the selected one or more vehicles. It may be appreciated that the one or more delivery routes may be determined based on the driver information and the first information 402A indicative of the first delivery request. Thus, the one or more second electronic devices 104 may receive the one or more delivery routes determined by the first electronic device 102. The received one or more delivery routes may help the driver of each of the set of vehicles 108 to navigate between the source location to the destination location in a timely manner such that the driver's preferences and the corresponding vehicle's constraints are aligned with the requirements of the first delivery request.

At 410, an operation of energy consumption information reception may be executed. In an embodiment, the circuitry 202 may be configured to receive the energy consumption information associated with each vehicle of the selected one or more vehicles, based on the transmitted one or more delivery routes. Based on the receipt of energy consumption information, the circuitry 202 may continuously refine route planning algorithms used to determine recommended routes, improve vehicle selection for specific delivery tasks, and provide more accurate estimates for future deliveries. The energy consumption information may also be used to calculate fair and accurate remuneration for drivers based on the actual energy efficiency of their deliveries, potentially incentivizing more efficient driving practices.

For example, the delivery of the first package may be made using an electric vehicle, such as, an electric delivery van that may be assigned a route through a city center. As the electric delivery van travels, onboard systems (e.g., TCUs) on the electric delivery van may continuously monitor and report energy consumption data. For instance, the onboard system may record that the electric delivery van used 15 kWh of electricity to cover a 30-mile route with multiple stops. Such recorded data may be transmitted back to the circuitry 202. Based on the recorded data, the circuitry 202 may assess the efficiency of the chosen route and the electric vehicle's performance.

In another example, a hybrid truck may be assigned a long-distance highway route. The energy consumption information received may show that the truck used 5 gallons of gasoline and 20 kWh of electricity to cover a 200-mile route. The energy consumption information of the truck may help the circuitry 202 to optimize future route assignments for hybrid vehicles, balancing the use of electric and gasoline power for maximum efficiency.

In another example, for a bicycle courier using an electric-assist bike, the circuitry 202 may receive data on both a physical effort of a rider and battery consumption of the electric-assist bike. For example, the received data may show that over a 4-hour shift covering 30 miles in a dense urban area, the bike's battery used 0.5 kWh of electricity, while the rider burned an estimated 1000 calories. Such received data may be used to optimize routes for human-powered vehicles and ensure fair compensation for the physical effort involved.

In an example, a refrigerated truck delivering perishable goods may provide energy consumption data that includes both the fuel used for transportation and the energy required to maintain the cargo's temperature. For instance, the circuitry 202 may receive information that the refrigerated truck used 10 gallons of diesel for a 100-mile trip, plus an additional 5 kWh of electricity to power the refrigeration unit. The received information may help in planning more efficient routes for temperature-sensitive deliveries.

In another example, in case drones are used for short-distance deliveries, the energy consumption information may include battery usage data. For example, a drone may report using 0.1 kWh of battery power for a 2-mile round trip delivery. The energy consumption information of the drone may be crucial for planning multiple deliveries within the drone's battery life and for scheduling recharging or battery swap operations.

At 412, an operation of remuneration information determination may be executed. In an embodiment, the circuitry 202 may be configured to determine the remuneration information associated with the driver of each vehicle of the selected one or more vehicles, based on the received energy consumption information. The remuneration information may be determined based on a dynamic and performance-based compensation model that incentivizes energy-efficient driving practices.

For example, an electric delivery van may complete a series of urban deliveries, consuming 12 kWh of electricity over a 40-mile route. The circuitry 202 may compare the consumed electricity (i.e., 12 kWh) to an average consumption of 15 kWh for similar routes. As a result, the driver may receive a bonus or higher remuneration rate due to their energy-efficient driving. In another example, a diesel truck may complete a 500-mile highway delivery, consuming 70 gallons of fuel. If the fuel consumption of the diesel truck is lower than the expected average for this route and load, the driver may receive additional compensation or fuel efficiency credits that can be redeemed for rewards.

In another example, a hybrid van may complete a mixed urban and highway route, optimally balancing between electric and gasoline power usage. If the overall energy consumption is lower than average for similar routes, the driver may receive a higher remuneration rate or additional credits towards their vehicle lease payments. In another example, in a scenario where drones may be used for last-mile deliveries, the circuitry 202 may track an energy efficiency of each drone operator. An operator who consistently achieves lower energy consumption per delivery (e.g., by optimizing flight paths or minimizing hover time) may receive higher remuneration or performance bonuses.

In an embodiment, the circuitry 202 may be configured to receive pedal assist information indicative of current or anticipated pedal assist associated with each vehicle of the selected one or more vehicles. The circuitry 202 may determine charging information of each vehicle of the selected one or more vehicles, based on the pedal assist information and the received energy consumption information. The determination of the remuneration information associated with the driver of each vehicle of the selected one or more vehicles is further based on the determined charging information. In an example, a bicycle courier may use an electric-assist bike and may complete multiple deliveries in a city center, using only 0.3 kWh of battery power over a 4-hour shift. The circuitry 202 may receive pedal assist information associated with the electric-assist bike over the 4-hour shift. Further, the circuitry 202 may determine charging information (for example, a usage of 0.3 kWh of battery power) of the electric-assist bike over the 4-hour shift. Herein, the determination of the remuneration information associated with the driver of the electric-assist bike may be further based on the determined charging information (i.e., 0.3 kWh). For instance, the low energy consumption and the physical effort of the rider may be factored in to calculate a remuneration of the rider, potentially offering a higher pay rate or fitness-related bonuses.

The remuneration of the riders may be directly tied to the energy consumption information, creating a clear incentive for drivers to adopt energy-efficient driving practices. Such an approach may not only reduce operational costs for the delivery service but also contribute to environmental sustainability goals. Further, the remuneration of the riders may be fair and transparent as the driver may be rewarded for their skill and efficiency rather than just the number of deliveries completed.

Traditional delivery models may often depend on a static fleet and fixed routes, which can lead to suboptimal fuel consumption, increased delivery times, and underutilization of resources. The present disclosure provides a cloud-based system designed to enhance the efficiency of package delivery services. The disclosed system may employ a network of diverse vehicles, each equipped with a Telematics Control Unit (TCU) or a compatible phone application, to facilitate communication with a centralized cloud platform. The cloud platform may play a central role in dynamically routing vehicles to designated pick-up and delivery points, taking into account the specific characteristics of each package and the available vehicle information. In contrast to the traditional delivery models, the disclosed dynamic routing based on characteristics of each package and available vehicles may lead to fuel saving, reduced delivery time, and efficient utilization of the vehicles.

The disclosed first electronic device 102 may be equipped with the circuitry 202 that performs several functions to streamline the delivery process. The circuitry 202 may receive information about a delivery request, including an origin and destination of a package, as well as details about the package itself. Based on the received information and profiles of available vehicles and drivers, the first electronic device 102 may select suitable vehicles and calculate efficient delivery routes. The delivery routes may then be communicated to the corresponding TCUs or the one or more second electronic devices 104 associated with the vehicles. The disclosed first electronic device 102 may also gather data on the energy consumed during delivery, which may be used to determine appropriate compensation for the drivers, thereby incentivizing efficient energy use and route adherence.

The disclosed first electronic device 102 may allow for real-time adjustments to delivery routes, ensuring that vehicles are used in the most efficient manner possible. By considering factors such as cargo size, vehicle availability, and fuel efficiency, the first electronic device 102 of the disclosure can reduce operational costs and environmental impact. Additionally, the provision of remuneration to drivers based on energy consumption of the vehicles of the respective drivers data may encourage the drivers to operate their vehicles more efficiently, which can lead to further cost savings and a reduction in carbon emissions. Overall, the disclosed first electronic device 102 may provide a substantial improvement over conventional delivery methods, offering a more adaptable, efficient, and environmentally friendly approach to package delivery.

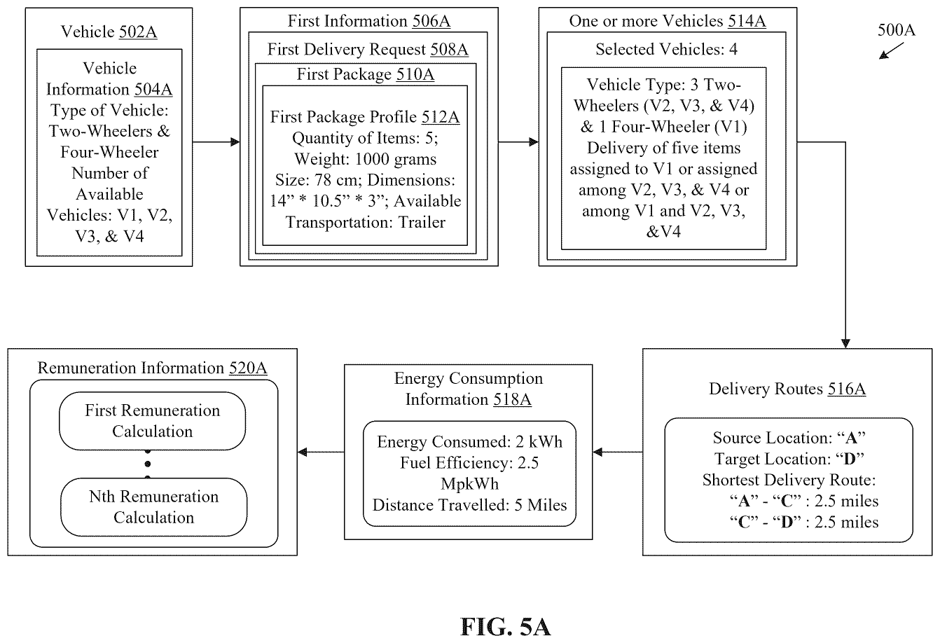

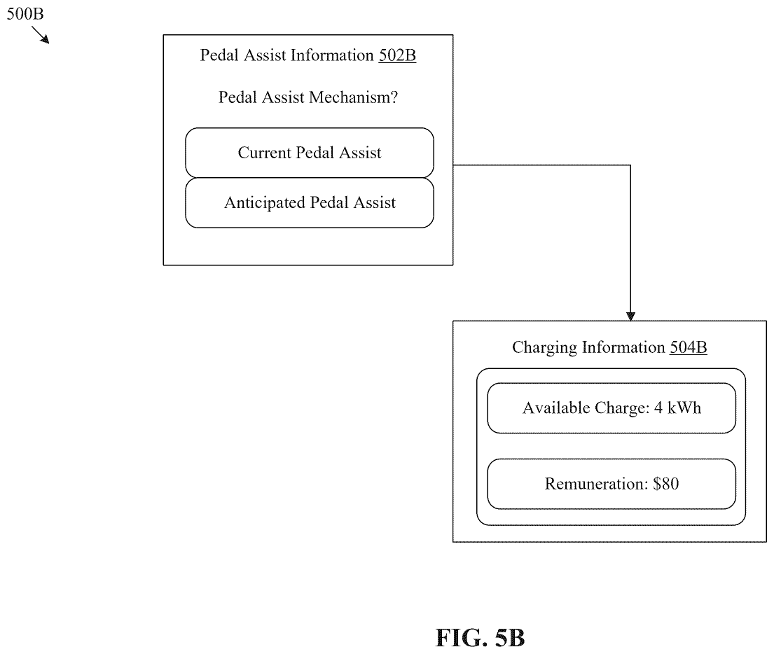

FIG. 5A is a block diagram that illustrates an exemplary scenario for cloud-based package delivery and vehicle energy consumption based rider remuneration, in accordance with one embodiment of the disclosure. FIG. 5A is explained in conjunction with elements from FIG. 1, FIG. 2, FIG. 3, and FIG. 4. With reference to FIG. 5A, there is shown an exemplary scenario 500A for the cloud-based package delivery and vehicle energy consumption based rider remuneration. The exemplary scenario 500A includes a vehicle 502A, first information 506A, one or more vehicles 514A, one or more delivery routes 516A, energy consumption information 518A, and remuneration information 520A.

The vehicle 502A may include suitable logic, control circuitry, interfaces, and/or code that may be configured to transmit, to the first electronic device 102, the driver information and the vehicle information associated with the vehicle 502A. Further, the vehicle 502A may receive from the first electronic device 102, the one or more delivery routes associated with the first delivery request of the first package from the source location to the target location. The first package may be associated with the first package profile. The received one or more delivery routes may be determined based on the driver information, and the first information indicative of the first delivery request. The vehicle 502A may be selected from the set of vehicles 108, based on the vehicle information and the package profile. Further, the vehicle 502A may determine the energy consumption information associated with the vehicle 502A, based on the received one or more delivery routes. Further, the vehicle 502A may receive the remuneration information associated with the driver of the vehicle 502A based on the received energy consumption information. The vehicle 502A may be similar to the first vehicle 108A, and hence, further details about the vehicle 502A are omitted here for the sake of brevity.

In an example, the vehicle information 504A may be determined by the TCU 318 of the vehicle 502A and transmitted to the circuitry 202 of the first electronic device 102. The vehicle information 504A may be at least one of the vehicle model, the vehicle type, the fuel efficiency, the carbon footprint, the cost of operation, the vehicle age, the vehicle mileage, or the cargo size associated with each vehicle of the selected one or more vehicles. For example, the vehicle information 504A received by the first electronic device 102 from multiple vehicles (including, for example, the vehicle 502A) may indicate that the vehicle types of the available vehicles are “Two-Wheeler” and “Four-Wheeler”. In an embodiment, the first delivery request of the first package from the source location to the target location may be fulfilled by the vehicle 502A. The first package may be associated with the first package profile. Further, the vehicle information 504A received by the circuitry 202 of the first electronic device 102 may display a number of vehicles available for the delivery of the first package from the source location to the target location. For example, the number of vehicles available for the delivery of the first package from the source location to the target location may be four vehicles designated by: “Vehicle-1 (V1)”, “Vehicle-2 (V2)”, “Vehicle-3 (V3)”, and “Vehicle-4 (V4)”. In an embodiment, either of the vehicles V1, V2, V3, or V4 may be available for the delivery of the first package, or all the vehicles V1, V2, V3, or V4 may be available for the delivery of the first package, based on the first package profile. In an embodiment, the vehicle information 504A may be displayed on a display device associated with the vehicle 502A or on a display device of the one or more second electronic devices 104 associated with the vehicle 502A. It may be appreciated that the first package profile may include at least one of the size of the first package, the dimensions of the first package, the quantity of items in the first package, the weight of the first package, or the transportation requirements associated with the first package.

In an example, the first electronic device 102 may receive the first information 506A indicative of a first delivery request 508A of a first package 510A from the source location to the target location. The first package 510A may be associated with a first package profile 512A. The first package profile 512A may be displayed by the control circuitry of the vehicle 502A. The first package profile 512A may represent the details associated with the first package 510A to be delivered from the source location to the target location. For example, the first package profile 512A may indicate that the quantity of items in the first package 510A are “five” items, the weight of the first package 510A is “1000 grams”, the size of the first package 510A is “78 cm”, the dimensions of the first package 510A is “14 inches*10.5 inches*3 inches”, and the transportation requirements associated with the first package 510A is a requirement of a “Trailer”.

The circuitry 202 of the first electronic device 102 may select the one or more vehicles 514A from the set of vehicles 108, based on the vehicle information 504A and further based on the first package profile 512A. The control circuitry of the vehicle 502A may display details related to the selected one or more vehicles 514A. For example, the control circuitry of the vehicle 502A may display that the number of the one or more selected vehicles 514A is “four”. The type of the selected one or more vehicles 514A, and information associated with an assignment of the first delivery request 508A including five items to the selected one or more vehicles 514A may be displayed by the control circuitry of the vehicle 502A. For example, the type of the selected one or more vehicles 514A may be “three two-wheelers” and “one four-wheeler”, in which the three two-wheelers may be shown as vehicles “V2”, “V3”, and “V4”, and the one four-wheeler may be shown as vehicle “V1”. Further, the information associated with the assignment of the first delivery request 508A may indicate that the five items of the first delivery request 508A be assigned to either vehicle “V1”, or to the vehicles “V2”, “V3”, and “V4”, or to all the vehicles “V1”, “V2”, “V3”, and “V4”.

In an example, the circuitry 202 of the first electronic device 102 may determine the one or more delivery routes 516A associated with the first delivery request 508A, based on the driver information and the received first information. For example, the one or more delivery routes 516A associated with the first delivery request 508A of the first package 510A from the source location, shown as “A”, to the target location, shown as “D”, may be determined, based on the driver information associated with the driver of each vehicle of the selected one or more vehicles 514A. Further, the shortest delivery route or the recommended delivery route may be determined from the one or more delivery routes 516A for each of the selected one or more vehicles 514A. For example, the shortest delivery route determined from the one or more delivery routes 516A may be a route including an intermediate location “C”, between the source location “A” to the target location “D”. The distance between the source location “A” to the location “C” may be “2.5 miles”, and the distance between the location “C” to the target location “D” may also be “2.5 miles”. Further, the determination of the shortest or recommended delivery route may be based on the current location of the driver and the energy consumption information associated with each of the selected one or more vehicles 514A.

In an example, the circuitry 202 of the first electronic device 102 may receive the energy consumption information 518A associated with each vehicle of the selected one or more vehicles 514A, based on the transmitted one or more delivery routes. For example, the energy consumption information 518A (which may be displayed by the control circuitry of the vehicle 502A) may indicate an amount of energy consumed by the selected one or more vehicles 514A, a fuel efficiency associated with the selected one or more vehicles 514A, and a total distance travelled by the selected one or more vehicles 514A. For example, the amount of energy consumed by the selected one or more vehicles 514A may be “2 Kilowatt-hour (kWh)”, the fuel efficiency associated with the selected one or more vehicles 514A may be “2.5 Miles per kilowatt-hour (MpkWh)”, and the total distance travelled by the selected one or more vehicles 514A may be “5 miles”. The fuel efficiency of 2.5 MpkWh may indicate that the vehicle 502A may be able to travel an estimated distance of 2.5 miles on 1 Kilowatt-hour (kWh) of battery of the vehicle 502A.

In an example, the circuitry 202 of the first electronic device 102 may determine the remuneration information 520A associated with the driver of each vehicle of the selected one or more vehicles 514A, based on the energy consumption information 518A.

The remuneration information 520A may be determined based on a calculation of the energy consumption information 518A. There may be different methods for calculating the energy consumption by the vehicle 502A. One of the methods may involve a calculation of a number of kilowatt-hours of electricity consumed by the vehicle 502A for every hundred kilometers distance covered by the vehicle 502A. In other words, the energy consumption may be determined in units of kWh/100 km for the vehicle 502A. The remuneration information 520A may be calculated based on various factors like the energy consumption information 518A, a cost of energy per liter of fuel, a type of charging station, and other factors. For example, the remuneration information 520A may depend on the charging associated with a type of charging station. The type of charging station may be classified under two categories, one may be a home charging station, and another may be a public charging station. The remuneration information 520A may depend on other variety of factors like at-home charging versus public charging. While at-home charging option may be the most cost-effective option for some drivers, public charging option may be a better option for other drivers. The remuneration information 520A may be calculated based on the distance travelled by the vehicle 502A for a particular duration. For example, the remuneration information 520A associated with the driver of the selected one or more vehicles 514A may be $60 for a distance of 60 miles covered by the vehicle 502A. As shown in FIG. 5A, there may be different remuneration calculation methods which are used for the calculation of the remuneration information 520A associated with the vehicle 502A. For example, the calculation of the remuneration information 520A may include a first remuneration calculation, . . . and an Nth remuneration calculation. The N number of remuneration calculation methods shown in FIG. 5A is presented merely as an example. The remuneration calculation method may include only one remuneration calculation methods or more than “N” remuneration calculation methods, without deviation from the scope of the disclosure.

It should be noted that the exemplary scenario 500A of FIG. 5A is for exemplary purposes and should not be construed to limit the scope of the disclosure.

FIG. 5B is a block diagram that illustrates an exemplary scenario for cloud-based package delivery and vehicle energy consumption based rider remuneration, in accordance with another embodiment of the disclosure. FIG. 5B is explained in conjunction with elements from FIG. 1, FIG. 2, FIG. 3, FIG. 4, and FIG. 5A. With reference to FIG. 5B, there is shown an exemplary scenario 500B for the cloud-based package delivery and the vehicle energy consumption based rider remuneration. The exemplary scenario 500B includes pedal assist information 502B and charging information 504B.

The circuitry 202 of the first electronic device 102 may receive the pedal assist information 502B indicative of the current or the anticipated pedal assist associated with each of the selected one or more vehicles 514A (e.g., the vehicle 502A). The circuitry 202 may determine the charging information 504B of each of the selected one or more vehicles 514A, based on the pedal assist information 502B and the received energy consumption information. The determination of the remuneration information 522A associated with the driver of each vehicle of the selected one or more vehicles 514A may be further based on the determined charging information.

In an example, the pedal assist information 502B may be displayed by the control circuitry of the vehicle 502A or the circuitry 202 of the first electronic device 102. The pedal assist information 502B may refer to information associated with selection of the pedal assist mechanism. For example, the information associated with the selection of the pedal assist mechanism may be presented in form of two options for selection. One option may be a “Current Pedal Assist” mechanism and another option may be an “Anticipated Pedal Assist” mechanism associated with the vehicle 502A. The charging information 504B may be determined based on the selection of either the current pedal assist mechanism or the anticipated pedal assist mechanism. Further, the charging information 504B may be determined based on the at-home charging option or the public charging option. In an example, in case of the at-home charging option, the cost of charging the vehicle 502A may be based on various factors, including size of the battery, the efficiency associated with the vehicle 502A, and cost of the electricity in a particular area. The cost of charging may also vary depending on time of day during charging of the vehicle 502A. In another example, in case of the public charging option, the cost of charging of the vehicle 502A may depend on type of charger used by the driver to charge the battery of the vehicle 502A. Further, the charging information 504B associated with the vehicle 502A may be displayed as an available charge associated with the vehicle 502A and the remuneration associated with the driver of the vehicle 502A. For example, the available charge associated with the vehicle 502A may be calculated as 4 kWh and the remuneration associated with the driver of the vehicles 502A may be calculated as USD 80 (80 dollars), for a distance of eight miles covered by the vehicle 502A. However, the remuneration associated with the driver may be calculated based on different methods and the available charge associated with the vehicle 502A.

It should be noted that the exemplary scenario 500B of FIG. 5B is for exemplary purposes and should not be construed to limit the scope of the disclosure.

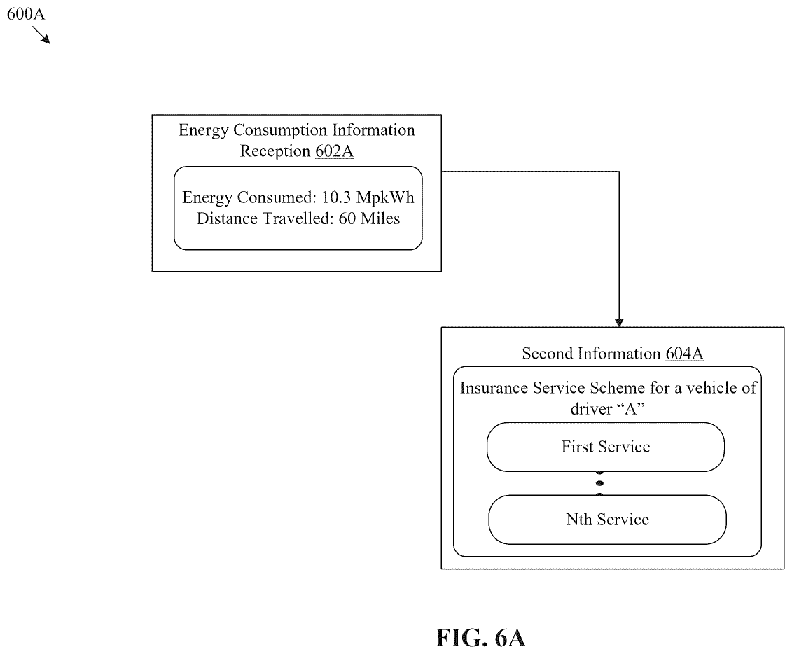

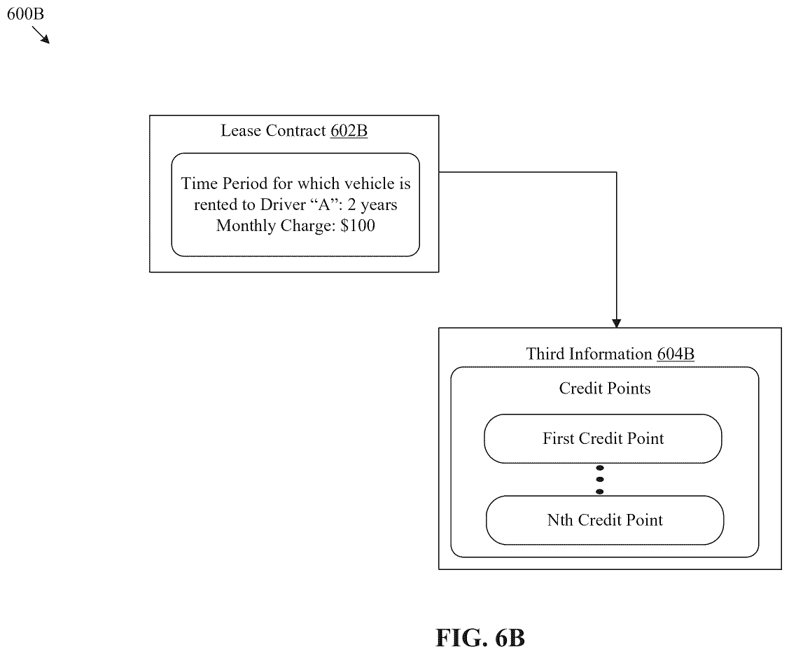

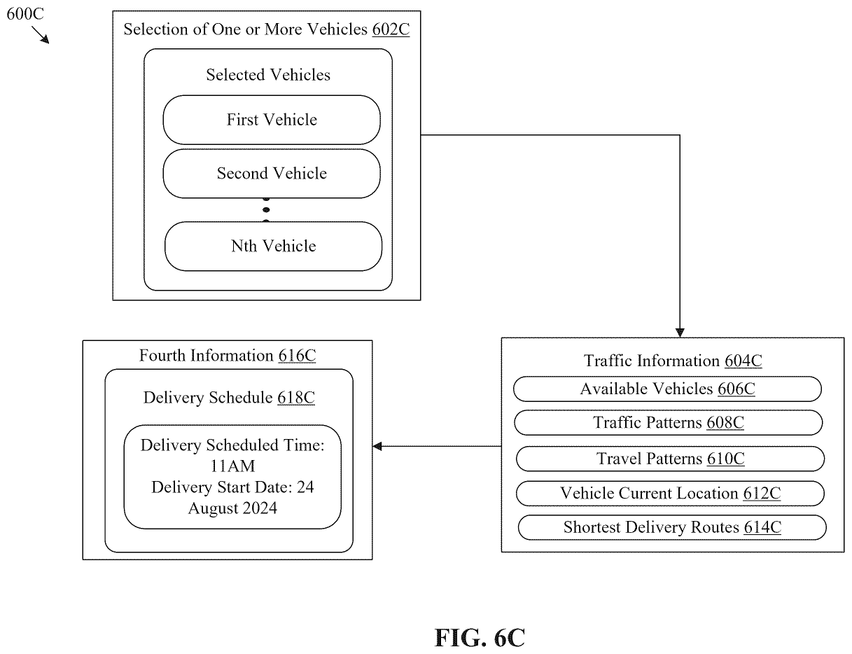

FIG. 6A is a block diagram that illustrates an exemplary scenario for cloud-based operation to facilitate package delivery and vehicle energy consumption based rider remuneration, in accordance with a first embodiment of the disclosure. FIG. 6A is explained in conjunction with elements from FIG. 1, FIG. 2, FIG. 3, FIG. 4, FIG. 5A, and FIG. 5B. With reference to FIG. 6A, there is shown an exemplary scenario 600A for the cloud-based operation to facilitate package delivery and vehicle energy consumption based rider remuneration. The exemplary scenario 600A includes an operation for energy consumption information reception 602A and also includes second information 604A associated with the vehicle 502A.

The circuitry 202 of the first electronic device 102 may receive the energy consumption information 518A associated with the selected one or more vehicles 514A (e.g., the vehicle 502A), based on the one or more delivery routes transmitted to the vehicle 502A. Further, the circuitry 202 may receive the second information 604A indicative of an insurance service associated with the selected one or more vehicles 514A (e.g., the vehicle 502A), based on the energy consumption information 518A. The determination of the one or more delivery routes associated with the first delivery request 508A may be further based on the received second information 604A.

In an example, the energy consumption information reception 602A may include information associated with the energy consumed by the vehicle 502A and the distance travelled by the vehicle 502A. For example, as shown in FIG. 6A, the energy consumed by the vehicle 502A may be 10.3 Miles per kilowatt hour, which implies that the vehicle 502A may be able to travel an estimated distance of 10.3 miles based on a usage of 1 Kilowatt-hour (kWh) of a battery of the vehicle 502A. The distance travelled by the vehicle 502A may be 60 miles, which is close to an estimated distance of 61.8 miles that may be covered by the vehicle 502A on 6 kWh of the battery of the vehicle 502A.

In an example, based on the received second information 604A, the control circuitry of the vehicle 502A, or the circuitry 202 of the first electronic device 102 may display information related to the insurance service associated with the vehicle 502A. The insurance service may refer to insurance service scheme associated with the vehicle 502A of the driver. For example, the second information 604A may indicate an insurance service scheme associated with the vehicle 502A of a driver “A”. The insurance service scheme may include a first service (such as, a third-party insurance), a second service (such as, a no-claim bonus), . . . and an Nth service (such as, an accident insurance cover). The “N” number of service schemes shown in FIG. 6A are presented merely as an example. The service scheme may include only one service scheme or more than “N” service schemes, without deviation from the scope of the disclosure.

In this embodiment, the circuitry 202 of the first electronic device 102 may determine the one or more delivery routes based on both the energy consumption information and the second information 604A related to the insurance services. For example, in a scenario where a delivery needs to be made from a warehouse to a residential area, the circuitry 202 of the first electronic device 102 may select an electric van (e.g., the vehicle 502A) for the delivery based on the package profile and vehicle information. For the electric van, the circuitry 202 may receive the energy consumption information 518A, which may indicate that the vehicle 502A consumes an average of 0.3 kWh per mile in urban areas and 0.25 kWh per mile on highways. Based on the energy consumption information 518A, the circuitry 202 of the first electronic device 102 may receive the second information 604A from an insurance provider. The second information 604A may include details about an insurance service tailored for electric delivery vehicles. For instance, the insurance service might offer lower premiums for routes that prioritize energy efficiency and safety.

As an example, the second information 604A may indicate that routes with more than 70% highway driving may qualify for a 10% premium discount, routes that avoid high-traffic areas during peak hours may qualify for an additional 5% discount, and routes that include charging stops at partner charging stations may qualify for a 3% discount per stop. Based on such second information 604A, the circuitry 202 may determine the one or more delivery routes not just based on distance and estimated delivery time, but also based on the potential insurance benefits. For example, routes “A” and “B” may be determined, wherein the route “A” may include 80% highway driving, may avoid peak traffic, and have one charging stop. Further, the route “B” may include 60% highway driving, may pass through some high-traffic areas, and may not have charging stops. While the route “B” may be slightly shorter, the circuitry 202 may select the route “A” because it qualifies for a total of 18% discount (i.e., 10% for highway driving, 5% for avoiding peak traffic, and 3% for the charging stop) on the insurance premium. The route “B” may not only optimize for energy efficiency but also reduce the overall operational cost by lowering insurance expenses. Hence, the disclosed first electronic device 102 may integrate energy consumption information with insurance premium discounts to determine the most cost-effective and efficient delivery routes, potentially leading to lower operational costs and increased sustainability of the delivery service.

It should be noted that the exemplary scenario 600A of FIG. 6A is for exemplary purposes and should not be construed to limit the scope of the disclosure.

FIG. 6B is a block diagram that illustrates an exemplary scenario for cloud-based operation to facilitate package delivery and vehicle energy consumption based rider remuneration, in accordance with a second embodiment of the disclosure. FIG. 6B is explained in conjunction with elements from FIG. 1, FIG. 2, FIG. 3, FIG. 4, FIG. 5A, FIG. 5B, and FIG. 6A. With reference to FIG. 6B, there is shown an exemplary scenario 600B for the cloud-based operation to facilitate package delivery and the vehicle energy consumption based rider remuneration. The exemplary scenario 600B includes a lease contract 602B between the driver and a vehicle lease company, and third information 604B.

The circuitry 202 of the first electronic device 102 may be configured to receive the third information 604B indicative of credit points associated with the driver of each vehicle (e.g., the vehicle 502A) of the selected one or more vehicles 514A, based on the lease contract 602B between the driver and the vehicle lease company. The determination of the one or more delivery routes 516A associated with the first delivery request 508A may be further based on the received third information 604B. In an embodiment, the credit points associated with the selected one or more vehicles (e.g., the vehicle 502A) may correspond to at least one of a free service ride, a free vehicle servicing, a discounted vehicle service, battery charging credits, or carbon credits associated with the selected one or more vehicles.

In an example, the lease contract 602B may include information about a certain time period for which the vehicle 502A has been rented to or leased out to the driver “A”, and monthly charges to be paid by the driver “A”, against the vehicle 502A. For example, the time period for which the vehicle 502A has been rented to the driver “A” may be two years, and the monthly charge to be paid by the driver “A” may be USD 100 (100 dollars).

In an example, the circuitry 202 of the first electronic device 102 may receive the third information 604B indicative of the credit points associated with the driver “A” of the vehicle 502A, based on a lease contract between the driver “A” and a vehicle lease company. It may be appreciated that the credit points associated with the selected one or more vehicles 514A may correspond to at least one of a free service ride, a free vehicle servicing, a discounted vehicle service, battery charging credits, or carbon credits associated with the selected one or more vehicles 514A. The credit points associated with the driver “A” of the vehicle 502A may be multiple credit points with each credit point of a different type. For example, the multiple credit points may include a first credit point, . . . and an Nth credit point. The N number of credit points shown in FIG. 6B is presented merely as an example. The credit points may include only one credit point or more than “N” credit points associated with the driver of each of the selected one or more vehicles 514A, without deviation from the scope of the disclosure.

In an embodiment, the circuitry 202 of the first electronic device 102 may apply a credit point model to the determination of the one or more delivery routes, wherein both a lease contract (i.e., a contract between the driver and a lease company) and the driver's performance may be factored in. For example, a driver “A” may lease an electric delivery van from a vehicle lease company. The lease contract may include a clause that allows the driver “A” to earn credit points based on a delivery performance and an energy efficiency of the driver “A”. The circuitry 202 may receive the third information 604B that may indicate that the driver “A” has accumulated “1000” credit points. For instance, “500” credit points may be earned for consistent completion of deliveries on time over a past month, “300” credit points may be earned for maintenance of an above-average energy efficiency rating, and “200” credit points may be earned for positive customer feedback on the deliveries. The earned credit points may be used to redeem various benefits. For instance, “500” credit points may be redeemed for a free vehicle servicing, “300” credit points may be exchanged for battery charging credits, thereby reducing the operational costs, and “200” points may qualify the driver “A” for a discounted vehicle service on a next maintenance check.

In an example, the determination of the one or more delivery routes may also be based on the credit points associated with the driver “A”. For example, routes “1” and “2” may be determined, wherein the route “1” may be longer route that includes a stop at a partner charging station where the driver can use the battery charging credits. Further, the route “2” may be a shorter route that may not include a charging stop. Though the route “2” may be shorter, the first electronic device 102 may select the route “1” because it may allow the driver “A” to utilize the earned credits, reducing overall operational costs. Thus, the route “1” may not only optimize for energy efficiency but also maximize the benefits that the driver “A” may have earned through previous performance on routes. Furthermore, based on a completion of the route “1” efficiently, the driver “A” may earn additional carbon credits, which could be used to offset the carbon footprint of future or past deliveries or be exchanged for other benefits in the future.

Hence, the circuitry 202 of the first electronic device 102 may integrate the credit point model with route determination, creating a virtuous cycle that may reward efficient and reliable drivers, reduce operational costs, and promote sustainable delivery practices. Such an approach may not only benefit the drivers but also enhance the overall efficiency and sustainability of the delivery service.

It should be noted that the exemplary scenario 600B of FIG. 6B is for exemplary purposes and should not be construed to limit the scope of the disclosure.

FIG. 6C is a block diagram that illustrates an exemplary scenario for cloud-based operation to facilitate package delivery and vehicle energy consumption based rider remuneration, in accordance with a third embodiment of the disclosure, in accordance with a third embodiment of the disclosure. FIG. 6C is explained in conjunction with elements from FIG. 1, FIG. 2, FIG. 3, FIG. 4, FIG. 5A, FIG. 5B, FIG. 6A, and FIG. 6B. With reference to FIG. 6C, there is shown an exemplary scenario 600C for the cloud-based operation to facilitate package delivery and the vehicle energy consumption based rider remuneration. The exemplary scenario 600C includes an operation for a selection of one or more vehicles 602C, and information such as, traffic information 604C, and fourth information 616C.

The circuitry 202 of the first electronic device 102 may select the one or more vehicles from the set of vehicles 108, based on the vehicle information associated with each vehicle of the set of vehicles 108, and further based on the first package profile 512A. Further, the circuitry 202 may determine the one or more delivery routes 516A associated with the first delivery request 508A, based on the driver information associated with the driver of each of the selected one or more vehicles 514A, and the received first information. The selected one or more vehicles 514A may be more than one vehicle selected for the delivery of the first package 510A from the source location to the target location. For example, the selected one or more vehicles 514A may include a first vehicle, a second vehicle, . . . and an Nth vehicle. The N number of vehicles shown in FIG. 6C is presented merely as an example. The selected one or more vehicles 514A may include only one selected vehicle or more than “N” selected vehicle associated with the delivery of the first package 510A, without deviation from the scope of the disclosure.

In an example, the control circuitry of the vehicle 502A or the circuitry 202 of the first electronic device 102 may be configured to receive the traffic information 604C associated with the selected one or more vehicles 514A. The determination of the one or more delivery routes 516A may be further based on the traffic information 604C. It may be appreciated that the traffic information 604C may include at least one of the network of available vehicles of the selected one or more vehicles 514A, the current location of the available vehicles, or traffic patterns associated with the selected one or more vehicles 514A. As shown in FIG. 60, the traffic information 604C may include available vehicles 606C, traffic patterns 608C associated with the selected one or more vehicles 514A, travel patterns 610C associated with the selected one or more vehicles 514A, vehicle current location 612C, and shortest delivery routes 614C. The available vehicles 606C may refer to the network of available vehicles for the fulfillment of the first delivery request 508A of the first package 510A from the source location to the target location. The traffic patterns 608C associated with the selected one or more vehicles 514A may refer to historical data related with the traffic during delivery of the first package 510A from the source location to the target location. The travel patterns 610C may refer to historical data related with the previous delivery routes determined for the delivery of the first package 510A. The vehicle current location 612C may be an updated and precise location of the driver to be detected during the delivery of the first package 510A from the source location to the target location. The shortest delivery routes 614C may be the delivery routes determined from the one or more delivery routes 516A for the driver, during execution of the first delivery request 508A of the first package 510A. The first package 510A may be associated with the first package profile 512A.

In an embodiment, the control circuitry of the vehicle 502A, or the circuitry 202 of the first electronic device 102 may be configured to receive the fourth information 616C indicative of a delivery schedule 618C associated with the selected one or more vehicles 514A. The determination of the one or more delivery routes 516A associated with the first delivery request 508A may be further based on the fourth information 616C. For example, information related with the delivery schedule 618C may be displayed on a display device (e.g., the display device 208A). The delivery schedule 618C may indicate a delivery scheduled time and a delivery start date associated with the delivery of the first package 510A from the source location to the target location. As shown in FIG. 6C, the delivery scheduled time associated with the delivery of the first package 510A may be displayed as “11 AM”, and the delivery start date associated with the delivery of the first package 510A may be displayed as “24 Aug. 2024”. It may be appreciated that the first package 510A may be associated with the first package profile 512A. The first package profile 512A may represent the details associated with the first package 510A to be delivered from the source location to the target location. For example, the first package profile 512A may be displayed which shows the quantity of items in the first package 510A, the weight of the first package 510A, the size of the first package 510A, the dimensions of the first package 510A, and available transportation for the execution of the first delivery request 508A of the first package 510A.

In an example, the circuitry 202 of the first electronic device 102 may use the delivery schedule 618C for the determination of the one or more delivery routes, to enable more efficient and coordinated deliveries. For example, in a scenario where a delivery driver “B” operates an electric van (e.g., the vehicle 502A) in a busy urban area, the control circuitry of the driver B's vehicle or the circuitry 202 of the first electronic device 102 may the receive fourth information 616C about the driver B's delivery schedule for the day. The fourth information 616C may include details such as, a scheduled pickup at a distribution center at 9:00 AM for multiple packages, a time-sensitive delivery to a business address by 11:00 AM, several residential deliveries with flexible timing throughout the afternoon, a scheduled battery charging stop at 2:00 PM, and a final pickup from a local retailer at 4:30 PM before returning to the depot. For the determination of the delivery routes 516A for the driver B's first delivery request 508A (e.g., the time-sensitive business delivery), the circuitry 202 may use the delivery schedule 618C. For instance, routes “1” and “2” may be determined, wherein the route “1” may be direct path to the business address, arriving at 10:30 AM, and the route “2” may be a slightly longer route that includes two residential deliveries on the way, arriving at the business address at 10:50 AM. While the route “1” may be shorter, the circuitry 202 may select the route “B” because it may allow the driver “B” to complete two additional deliveries while still meeting the 11:00 AM deadline for the business delivery. Such a route optimization considers not just the immediate delivery request, but also the overall efficiency of the driver B's entire delivery schedule. Furthermore, the circuitry 202 may adjust the route if there are any changes to the schedule. For example, if the 2:00 PM charging stop is no longer necessary due to lower-than-expected energy consumption, the circuitry 202 may recalculate the afternoon routes to include more deliveries instead.

Hence, by using the delivery schedule 618C for the determination of the one or more delivery routes, the circuitry 202 can create more efficient routes that may maximize the number of deliveries while meeting all time constraints and energy management needs. Such an approach may lead to increased productivity, better resource utilization, and improved customer satisfaction due to more accurate delivery time estimates.

It should be noted that the exemplary scenario 600C of FIG. 6C is for exemplary purposes and should not be construed to limit the scope of the disclosure.

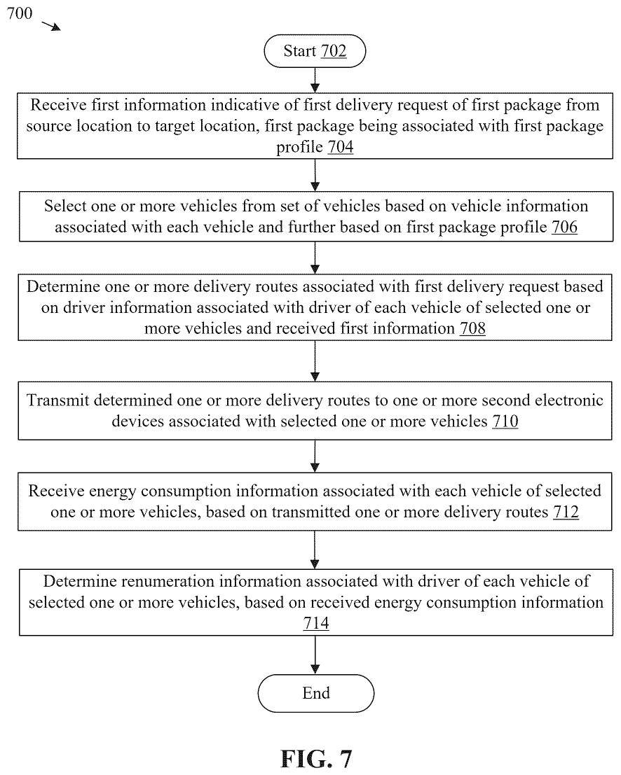

FIG. 7 is a flowchart that illustrates exemplary operations of a method for the cloud-based package delivery and the vehicle energy consumption based rider remuneration, in accordance with one embodiment of the disclosure. FIG. 7 is described in conjunction with FIG. 1, FIG. 2, FIG. 3, FIG. 4, FIG. 5A, FIG. 5B, FIG. 6A, FIG. 6B, and FIG. 6C. With reference to FIG. 7, there is shown a flowchart 700. The flowchart 700 includes operations from 702 to 714 that may be implemented, for example, by the circuitry 202 of the first electronic device 102 of FIG. 2. The operations of the flowchart 700 may start at 702 and proceed to 704.

At 704, the first information 402A, that may be indicative of the first delivery request 508A of the first package 510A from the source location to the target location, may be received. The first package 510A may be associated with the first package profile 512A. In an embodiment, the circuitry 202 may be configured to receive the first information 402A indicative of the first delivery request 508A of the first package 510A from the source location to the target location. Further, the first package profile 512A may include at least one of the quantity of items in the first package 510A, the weight of the first package 510A, the size of the first package 510A, the dimensions of the first package 510A, and the transportation requirements associated with the first package 510A. Details related to the reception of the first information are provided, for example, in FIG. 4 (at 402).

At 706, the one or more vehicles 514A may be selected from the set of vehicles 108 based on the vehicle information 504A associated with each vehicle, and further based on the first package profile 512A. In an embodiment, the circuitry 202 may be configured to select the one or more vehicles 514A from the set of vehicles 108 based on the vehicle information 504A associated with each vehicle, and further based on the first package profile 512A. Further, the vehicle information 504A may include at least one of the vehicle model, the vehicle type, the fuel efficiency, the carbon footprint, the cost of operation, the vehicle age, the vehicle mileage, or the cargo size associated with each vehicle of the selected one or more vehicles 514A. Details related to the selection of the one or more vehicles are provided, for example, in FIG. 4 (at 404).

At 708, the one or more delivery routes 516A associated with the first delivery request 508A may be determined, based on the driver information associated with the driver of each vehicle of the selected one or more vehicles 514A and the received first information 402A. In an embodiment, the circuitry 202 may be configured to determine the one or more delivery routes 516A associated with the first delivery request 508A, based on the driver information associated with the driver of each vehicle of the selected one or more vehicles 514A and the received first information 402A. Further, the driver information may include at least one of the lifestyle information, the habit information, the delivery servicing preference, the living location, the fitness information, the days and times of travel, or the commuting patterns associated with the driver. Details related to the determination of the one or more delivery routes 516A are provided, for example, in FIG. 4 (at 406).

At 710, the determined one or more delivery routes may be transmitted to the one or more second electronic devices 104 associated with the selected one or more vehicles 514A. In an embodiment, the circuitry 202 may be configured to transmit the determined one or more delivery routes to the one or more second electronic devices 104 associated with the selected one or more vehicles 514A. Further, the recommended delivery route or the shortest delivery route may be determined from the one or more delivery routes 516 for the selected one or more vehicles 514A. Details related to the transmission of the determined one or more delivery routes are provided, for example, in FIG. 4 (at 408).

At 712, the energy consumption information 518A associated with each of the selected one or more vehicles 514A may be received, based on the transmitted one or more delivery routes. In an embodiment, the circuitry 202 may be configured to receive the energy consumption information 518A associated with each of the selected one or more vehicles 514A, based on the transmitted one or more delivery routes. Further, the determination of the recommended delivery route may be based on the current location of the driver and the energy consumption information 518A associated with each of the selected one or more vehicles 514A. Details related to the reception of the energy consumption information associated with the selected one or more vehicles 514A are provided, for example, in FIG. 4 (at 410).

At 714, the remuneration information 520A associated with the driver of each of the selected one or more vehicles 514A may be determined, based on the received energy consumption information. In an embodiment, the circuitry 202 may be configured to determine the remuneration information 520A associated with the driver of each of the selected one or more vehicles 514A, based on the received energy consumption information. Further, the determination of the remuneration information 520A associated with the driver of the selected one or more vehicles 514A may be based on the charging information 504B of the selected one or more vehicles 514A. Details related to the determination of the remuneration information associated with the driver are provided, for example, in FIG. 4 (at 412). Control may pass to end.

Although the flowchart 700 is illustrated as discrete operations, such as, 704, 706, 708, 710, 712, and 714 the disclosure is not so limited. Accordingly, in certain embodiments, such discrete operations may be further divided into additional operations, combined into fewer operations, or eliminated, depending on the particular implementation without detracting from the essence of the disclosed embodiments.

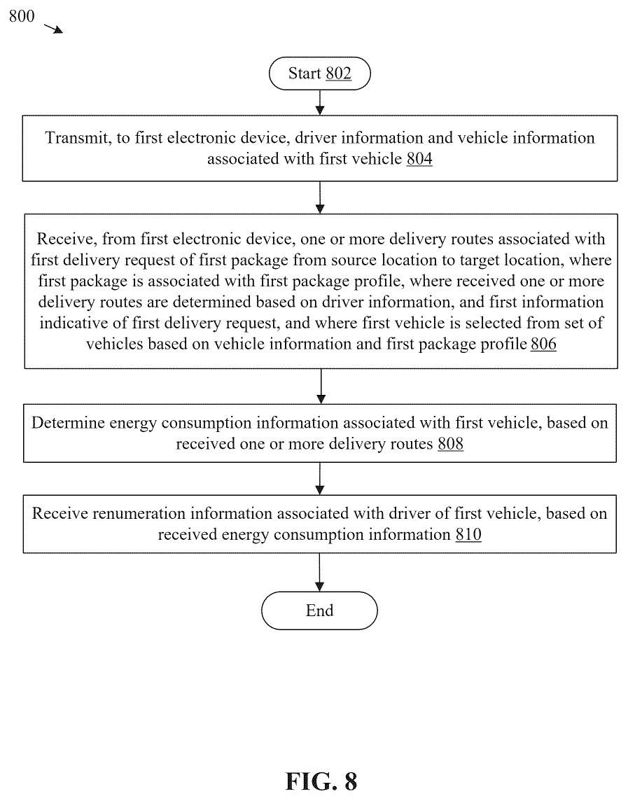

FIG. 8 is a flowchart that illustrates exemplary operations of a method for the cloud-based package delivery and the vehicle energy consumption based rider remuneration, in accordance with another embodiment of the disclosure. FIG. 8 is described in conjunction with FIG. 1, FIG. 2, FIG. 3, FIG. 4, FIG. 5A, FIG. 5B, FIG. 6A, FIG. 6B, FIG. 6C, and FIG. 7. With reference to FIG. 8, there is shown a flowchart 800. The flowchart 800 may include operations from 802 to 810 that may be implemented, for example, by the circuitry 202 of the first electronic device 102 of FIG. 2 or the telematics control unit (TCU) 318 of the first vehicle 108A. The operations of the flowchart 800 may start at 802 and proceed to 804.

At 804, the driver information and the vehicle information 504A associated with the first vehicle 108A may be transmitted to the first electronic device 102. In an embodiment, the TCU 318 may be configured to transmit the driver information and the vehicle information 504A associated with the first vehicle 108A to the first electronic device 102. The driver information may include at least one of the lifestyle information, the habit information, the delivery servicing preference, the living location, the fitness information, the days and times of travel, or the commuting patterns associated with the driver. Details of the transmission of the driver information and the vehicle information are further provided, for example, in FIG. 4.

At 806, the one or more delivery routes 516A associated with the first delivery request 508A of the first package 510A from the source location to the target location may be received. The first package 510A may be associated with the first package profile 512A. The received one or more delivery routes are determined based on the driver information, and the first information 402A indicative of the first delivery request 508A. Further the first vehicle 108A may be selected from the set of vehicles 108, based on the vehicle information 504A and the first package profile 512A. In an embodiment, the TCU 318 may be configured to receive the one or more delivery routes 516A associated with the first delivery request 508A of the first package 510A from the source location to the target location. The one or more delivery routes 516A may be determined by the first electronic device 102 and may be transmitted by the first electronic device 102 to the TCU 318. Details of the reception of the one or more delivery routes are further provided, for example, in FIG. 4.

At 808, the energy consumption information 518A associated with the first vehicle 108A may be determined, based on the received one or more delivery routes 516A. In an embodiment, the TCU 318 may be configured to determine the energy consumption information 518A associated with the first vehicle 108A, based on the received one or more delivery routes 516A. Details of the determination of the energy consumption information are further provided, for example, in FIG. 4.

At 810, the remuneration information 520A associated with the driver of the first vehicle 108A may be received, based on the received energy consumption information 518A. In an embodiment, the TCU 318 may be configured to receive the remuneration information 520A associated with the driver of the first vehicle 108A, based on the received energy consumption information 518A. Details of the reception of the remuneration information are further provided, for example, in FIG. 4. Control may pass to end.

Although the flowchart 800 is illustrated as discrete operations, such as 802, 804, 806, 808, and 810 the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of instructions executable by a machine and/or a computer (such as, the circuitry 202). The instructions may cause the machine and/or computer (for example, the first electronic device 102) to perform operations that may include receiving the first information 402A indicative of the first delivery request 508A of the first package 510A from the source location to the target location. The first package 510A may be associated with the first package profile 512A. The operations may further include selecting the one or more vehicles 514A from the set of vehicles 108, based on the vehicle information associated with each vehicle of the set of vehicles 108, and further based on the first package profile 512A. The operations may further include determining the one or more delivery routes 516A associated with the first delivery request 508A, based on the driver information associated with the driver of each vehicle of the selected one or more vehicles 514A, and the received first information 506A. The operations may further include transmitting the determined one or more delivery routes to the one or more second electronic devices 104 associated with the selected one or more vehicles 514A. The operations may further include receiving the energy consumption information 518A associated with each vehicle of the selected one or more vehicles 514A, based on the transmitted one or more delivery routes. The operations may further include determining the remuneration information 520A associated with the driver of each vehicle of the selected one or more vehicles 514A, based on the received energy consumption information 518A.

Various embodiments of the disclosure may provide a non-transitory, computer-readable medium and/or storage medium, and/or a non-transitory machine readable medium and/or storage medium stored thereon, a set of instructions executable by a machine and/or a computer (such as, the circuitry 202 of the first electronic device 102). The instructions may cause the machine and/or computer (for example, the telematics control unit (TCU) 318 of the first vehicle 108A) to perform operations that include transmitting, to the first electronic device 102, the driver information and the vehicle information 504A associated with the first vehicle 108A. The operations may further include receiving from the first electronic device 102, the one or more delivery routes 516A associated with the first delivery request 508A. The operations may further include determining the energy consumption information 518A associated with the first vehicle 108A, based on the received one or more delivery routes. The operations may further include receiving the remuneration information 520A associated with the driver of the first vehicle 108A based on the received energy consumption information.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments that fall within the scope of the appended claims.

1. A first electronic device, comprising:
circuitry configured to:
receive first information indicative of a first delivery request of a first package from a source location to a target location, the first package being associated with a first package profile;
select one or more vehicles from a set of vehicles, based on vehicle information associated with each vehicle of the set of vehicles, and further based on the first package profile;
determine one or more delivery routes associated with the first delivery request, based on driver information associated with a driver of each vehicle of the selected one or more vehicles, and the received first information;
transmit the determined one or more delivery routes to one or more second electronic devices associated with the selected one or more vehicles;
receive, during vehicle operation and in real-time, telematics-based energy consumption information measured by on-board sensors and communicated through a telematics control unit (TCU) associated with each vehicle of the selected one or more vehicles, the telematics-based energy consumption information including sensor data representative of powertrain load, speed and battery state of charge, wherein the data is governed and transmitted based on the transmitted one or more delivery routes;
receive pedal assist information indicative of current or anticipated pedal assist associated with each vehicle of the selected one or more vehicles;
determine charging information of each vehicle of the selected one or more vehicles based on the pedal assist information and the received energy consumption information and the received energy-consumption information;
generate, by execution of control instructions within the circuitry, a driver-feedback signal or vehicle-control signal to adjust at least one vehicle-operation parameter comprising motor torque, speed limit, or charging rate, based on the determined charging information and the measured energy-consumption information, whereby energy-efficiency of the modified in real time; and
determine remuneration information associated with the driver of each vehicle of the selected one or more vehicles, wherein the remuneration is determined as a function of the telematics-based energy consumption information and is further adjusted based on the determined charging information and the vehicle-operation parameter adjustments.

2. (canceled)

3. The first electronic device according to claim 1, wherein the circuitry is further configured to:
determine, for each vehicle of the selected one or more vehicles, a recommended delivery route from the one or more delivery routes, wherein
the determination of the recommended delivery route is based on a current location of the driver and the energy consumption information associated with each vehicle of the selected one or more vehicles.

4. The first electronic device according to claim 1, wherein the first information is received from a third electronic device of one or more retailers.

5. The first electronic device according to claim 1, wherein the circuitry is further configured to:
receive second information indicative of an insurance service associated with the selected one or more vehicles, based on the energy consumption information, wherein
the determination of the one or more delivery routes associated with the first delivery request is further based on the received second information.

6. The first electronic device according to claim 1, wherein the circuitry is further configured to:
receive third information indicative of credit points associated with the driver of each vehicle of the selected one or more vehicles, based on a lease contract between the driver and a vehicle lease company, wherein
the determination of the one or more delivery routes associated with the first delivery request is further based on the received third information.

7. The first electronic device according to claim 6, wherein the credit points associated with the one or more vehicles corresponds to at least one of a free service ride, a free vehicle servicing, a discounted vehicle service, battery charging credits, or carbon credits associated with the selected one or more vehicles.

8. The first electronic device according to claim 1, wherein the circuitry is further configured to:
receive fourth information indicative of a delivery schedule associated with the selected one or more vehicles, wherein
the determination of the one or more delivery routes associated with the first delivery request is further based on the fourth information.

9. The first electronic device according to claim 1, wherein the driver information includes at least one of: lifestyle information, habit information, a delivery servicing preference, a living location of the driver, fitness information, days and time of travel, or a commuting patterns.

10. The first electronic device according to claim 1, wherein the circuitry is further configured to:
receive the vehicle information associated with each vehicle of the selected one or more vehicles, wherein
the determination of the one or more delivery routes is further based on the vehicle information.

11. The first electronic device according to claim 10, wherein the received vehicle information includes at least one of: a vehicle model, a vehicle type, a fuel efficiency, a carbon footprint, a cost of operation, a vehicle age, a vehicle mileage, or a cargo size associated with each vehicle of the selected one or more vehicles.

12. The first electronic device according to claim 1, wherein the circuitry is further configured to:
receive traffic information associated with the selected one or more vehicles, wherein
the determination of the one or more delivery routes is further based on the traffic information.

13. The first electronic device according to claim 12, wherein the received traffic information includes at least one of: a network of available vehicles of the selected one or more vehicles, a current location of the available vehicles, or traffic patterns.

14. The first electronic device according to claim 1, wherein the first package profile includes at least one of: a size of the first package, dimensions of the first package, quantity of items in the first package, weight of the first package, or transportation requirements associated with the first package.

15. A first vehicle, comprising:
a telematics control unit (TCU) configured to:
transmit, to a first electronic device, driver information and vehicle information associated with the first vehicle;
receive, from the first electronic device, one or more delivery routes associated with a first delivery request of a first package from a source location to a target location, wherein
the first package is associated with a first package profile,
the received one or more delivery routes are determined based on the driver information, and first information indicative of the first delivery request, and
the first vehicle is selected from a set of vehicles, based on the vehicle information and the first package profile;
measure, during vehicle operation and in real-time, a telematics-based energy-consumption data using on-board vehicle sensors including at least one of a speed sensor, a torque sensor, a battery state-of-charge sensor, and a pedal assist sensor, and communicate the measured data through the TCU to the first electronic device;
determine energy-consumption information for the vehicle based on the measured sensor data and the received delivery routes;
determine pedal assist information indicative of current or anticipated pedal assist associated with the first vehicle;
determine charging information of the vehicle based on the determined pedal-assist information and the determined energy-consumption information;
generate, by execution of control instructions within the TCU, a control signal to adjust at least one vehicle-operation parameter comprising motor torque, battery charging rate, or power-assist level based on the determined charging information and the measured sensor data, whereby energy-consumption efficiency of the vehicle is modified in real-time; and
receive remuneration information associated with a driver of the first vehicle, wherein the remuneration is determined as a function of the telematics-based energy-consumption information and is further adjusted based on the determined charging information and the vehicle-operated parameter adjustment.

16. (canceled)

17. The vehicle according to claim 15, wherein the TCU is further configured to:
receive, for the first vehicle, a recommended delivery route from the one or more delivery routes, wherein
the reception of the recommended delivery route is based on a current location and the energy consumption information associated with the first vehicle.

18. The vehicle according to claim 15, wherein the driver information includes at least one of: lifestyle information, habit information, a delivery servicing preference, a living location of the driver, fitness information, days and time of travel, or a commuting patterns.

19. The vehicle according to claim 15, wherein the TCU is further configured to:
transmit, the vehicle information associated with the first vehicle, wherein
the one or more delivery routes are determined further based on the vehicle information.

20. A method, comprising:
in a first electronic device comprising circuitry and a telematics control interface:
receiving first information indicative of a first delivery request of a first package from a source location to a target location, the first package being associated with a first package profile;
selecting one or more vehicles from a set of vehicles, based on vehicle information associated with each vehicle of the set of vehicles, and further based on the first package profile;
determining one or more delivery routes associated with the first delivery request, based on driver information associated with a driver of each vehicle of the selected one or more vehicles, and the received first information;
transmitting the determined one or more delivery routes to one or more second electronic devices associated with the selected one or more vehicles;
receiving, during vehicle operation and in real-time, telematics-based energy consumption information measured by on-board vehicle sensors and communicated through a telematics control unit (TCU) associated with each of the selected one or more vehicles, the telematics-based energy-consumption information including sensor data representative of powertrain load, speed, and battery state of charge;
determining pedal assist information indicative of current or anticipated pedal assist associated with each vehicle of the selected one or more vehicles;
determining charging information of each vehicle of the selected one or more vehicles based on the pedal-assist information and the received energy-consumption information;
executing, by the circuitry of the first electronic device, control logic that generates a driver-feedback signal or vehicle-control signal to adjust at least one vehicle-operation parameter comprising motor torque, speed limit, or charging rate based on the determined charging information and the measured sensor data, whereby energy-consumption efficiency of the vehicle is modified in real time; and
determining remuneration information associated with the driver of each vehicle of the selected one or more vehicles, wherein the remuneration is determined as a function of the telematics-based energy consumption information and is further adjusted based on the determined charging information and the vehicle-operation parameter adjustment.
